(19) United States
(12) Patent Application Publication
(10) Pub. No.: US 2024/0201456 A1
(43) Pub. Date: Jun. 20, 2024

(54) THIN ILLUMINATION LAYER WAVEGUIDE AND METHODS OF FABRICATION

(71) Applicant: Magic Leap, Inc., Plantation, FL (US)

(72) Inventors: Vikramjit SINGH, Pflugerville, TX (US); Jason Allen SHULTZ, Miami, FL (US); Frank Y. XU, Austin, TX (US); Robert D. TEKOLSTE, Fort Lauderdale, FL (US)

(21) Appl. No.: 18/556,856

(22) PCT Filed: Apr. 28, 2022
(86) PCT No.: PCT/US2022/071988

§ 371 Date: Oct. 23, 2023

Related U.S. Application Data
(60) Provisional application No. 63/182,617, filed on Apr. 30, 2021.

(51) Int. Cl. G02B 6/42; G02B 27/01

(52) U.S. Cl. CPC G02B 6/4206; G02B 27/0172; G02B 2027/0178

(57) ABSTRACT

Disclosed herein are systems and methods for displays, such as for a head wearable device. An example display can include an infrared illumination layer, the infrared illumination layer including a waveguide having a first face and a second face, the first face disposed opposite the second face. The illumination layer may also include an in-coupling grating disposed on the first face, the in-coupling grating configured to couple light into the waveguide to generate internally reflected light propagating in a first direction. The illumination layer may also include a plurality of out-coupling gratings disposed on at least one of the first face and the second face, the plurality of out-coupling gratings configured to receive the internally reflected light and couple the internally reflected light out of the waveguide.

### CROSS-REFERENCE TO RELATED APPLICATIONS

This application claims priority to U.S. Provisional Application No. 63/182,617, filed on Apr. 30, 2021, the contents of which are incorporated by reference herein in its entirety.

### FIELD

This disclosure relates in general to systems for displaying visual information, and in particular to eyepieces for displaying visual information in an augmented reality or mixed reality environment.

### BACKGROUND

Virtual environments are ubiquitous in computing environments, finding use in video games (in which a virtual environment may represent a game world); maps (in which a virtual environment may represent terrain to be navigated); simulations (in which a virtual environment may simulate a real environment); digital storytelling (in which virtual characters may interact with each other in a virtual environment); and many other applications. Modern computer users are generally comfortable perceiving, and interacting with, virtual environments. However, users' experiences with virtual environments can be limited by the technology for presenting virtual environments. For example, conventional displays (e.g., 2D display screens) and audio systems (e.g., fixed speakers) may be unable to realize a virtual environment in ways that create a compelling, realistic, and immersive experience.

Virtual reality (“VR”), augmented reality (“AR”), mixed reality (“MR”), and related technologies (collectively, “XR”) share an ability to present, to a user of an XR system, sensory information corresponding to a virtual environment represented by data in a computer system. This disclosure contemplates a distinction between VR, AR, and MR systems (although some systems may be categorized as VR in one aspect (e.g., a visual aspect), and simultaneously categorized as AR or MR in another aspect (e.g., an audio aspect)). As used herein, VR systems present a virtual environment that replaces a user's real environment in at least one aspect; for example, a VR system could present the user with a view of the virtual environment while simultaneously obscuring his or her view of the real environment, such as with a light-blocking head-mounted display. Similarly, a VR system could present the user with audio corresponding to the virtual environment, while simultaneously blocking (attenuating) audio from the real environment.

VR systems may experience various drawbacks that result from replacing a user's real environment with a virtual environment. One drawback is a feeling of motion sickness that can arise when a user's field of view in a virtual environment no longer corresponds to the state of his or her inner ear, which detects one's balance and orientation in the real environment (not a virtual environment). Similarly, users may experience disorientation in VR environments where their own bodies and limbs (views of which users rely on to feel “grounded” in the real environment) are not directly visible. Another drawback is the computational burden (e.g., storage, processing power) placed on VR systems, which must present a full 3D virtual environment, particularly in real-time applications that seek to immerse the user in the virtual environment. Similarly, such environments may need to reach a very high standard of realism to be considered immersive, as users tend to be sensitive to even minor imperfections in virtual environments—any of which can destroy a user's sense of immersion in the virtual environment. Further, another drawback of VR systems is that such applications of systems cannot take advantage of the wide range of sensory data in the real environment, such as the various sights and sounds that one experiences in the real world. A related drawback is that VR systems may struggle to create shared environments in which multiple users can interact, as users that share a physical space in the real environment may not be able to directly see or interact with each other in a virtual environment.

As used herein, AR systems present a virtual environment that overlaps or overlays the real environment in at least one aspect. For example, an AR system could present the user with a view of a virtual environment overlaid on the user's view of the real environment, such as with a transmissive head-mounted display that presents a displayed image while allowing light to pass through the display into the user's eye. Similarly, an AR system could present the user with audio corresponding to the virtual environment, while simultaneously mixing in audio from the real environment. Similarly, as used herein, MR systems present a virtual environment that overlaps or overlays the real environment in at least one aspect, as do AR systems, and may additionally allow that a virtual environment in an MR system may interact with the real environment in at least one aspect. For example, a virtual character in a virtual environment may toggle a light switch in the real environment, causing a corresponding light bulb in the real environment to turn on or off. As another example, the virtual character may react (such as with a facial expression) to audio signals in the real environment. By maintaining presentation of the real environment, AR and MR systems may avoid some of the aforementioned drawbacks of VR systems; for instance, motion sickness in users is reduced because visual cues from the real environment (including users' own bodies) can remain visible, and such systems need not present a user with a fully realized 3D environment in order to be immersive. Further, AR and MR systems can take advantage of real world sensory input (e.g., views and sounds of scenery, objects, and other users) to create new applications that augment that input.

Presenting a virtual environment in a realistic manner to create an immersive experience for the user in a robust and cost effective manner can be difficult. For example, a head mounted display can include an optical system having one or more multi-layered eyepieces. The eyepiece can be an expensive and fragile component that includes multiple layers that perform different functions. For example, one or more layers may be used to display virtual content to the user and one or more layers may be used as an infrared (IR) illumination layer for eye-tracking. The multiple layers may result in a bulky eyepiece that adds weight to a MR system. Additionally, light transmission loss due to reflection and haze on the surface of the layers can affect the quality of the virtual content. While the illumination layer can include anti-reflective films and/or coatings, such films can add cost and complexity to the optical system. Thus, it is desirable to improve the transmittance of the optical system in a lightweight and compact form factor.

### BRIEF SUMMARY

Disclosed herein are systems and methods for displays, such as for a head wearable device. An example display can include an infrared illumination layer, the infrared illumination layer including a waveguide having a first face and a second face, the first face disposed opposite the second face. The illumination layer may also include an in-coupling grating disposed on the first face, the in-coupling grating configured to couple light into the waveguide to generate internally reflected light propagating in a first direction. The illumination layer may also include a plurality of out-coupling gratings disposed on at least one of the first face and the second face, the plurality of out-coupling gratings configured to receive the internally reflected light and couple the internally reflected light out of the waveguide. Embodiments disclosed herein may provide a robust illumination layer that can reduce the haze associated with an illumination layer. Moreover, embodiments disclosed herein can provide lightweight and compact optical stack. Further, embodiments disclosed herein may provide for improved transmittance of light from the illumination layer.

### BRIEF DESCRIPTION OF THE DRAWINGS

FIGS. 1A-1C illustrate an example mixed reality environment, according to one or more embodiments of the disclosure.

FIGS. 2A-2D illustrate components of an example mixed reality system that can be used to generate and interact with a mixed reality environment, according to one or more embodiments of the disclosure.

FIG. 3A illustrates an example mixed reality handheld controller that can be used to provide input to a mixed reality environment, according to one or more embodiments of the disclosure.

FIG. 3B illustrates an example auxiliary unit that can be used with an example mixed reality system, according to one or more embodiments of the disclosure.

FIG. 4 illustrates an example functional block diagram for an example mixed reality system, according to one or more embodiments of the disclosure.

FIG. 5 illustrates an example optical system for an example mixed reality system, according to one or more embodiments of the disclosure.

FIGS. 6A-6B illustrate examples of illumination layers for an example mixed reality system, according to one or more embodiments of the disclosure.

FIGS. 7A-7D illustrate examples of illumination layers for an example mixed reality system, according to one or more embodiments of the disclosure.

FIGS. 8A-8C illustrate examples of optical systems for an example mixed reality system, according to one or more embodiments of the disclosure.

FIGS. 9A-9C illustrate examples of optical systems for an example mixed reality system, according to one or more embodiments of the disclosure.

FIG. 10 illustrates an example illumination layer for an example mixed reality system, according to one or more embodiments of the disclosure.

FIGS. 11A-11C illustrate examples of illumination layers for an example mixed reality system, according to one or more embodiments of the disclosure.

FIGS. 12A-12F illustrate examples of illumination layers for an example mixed reality system, according to one or more embodiments of the disclosure.

FIG. 13 illustrates an example spreader region of an illumination layer for an example mixed reality system, according to one or more embodiments of the disclosure.

FIGS. 14A-14I illustrate examples of illumination layers for an example mixed reality system, according to one or more embodiments of the disclosure.

FIGS. 15A-15C illustrate examples of illumination layers for an example mixed reality system, according to one or more embodiments of the disclosure.

FIGS. 16A-16H illustrate examples of nano-patterns for an illumination layer for an example mixed reality system, according to one or more embodiments of the disclosure.

FIGS. 17A-17E illustrate examples of nano-patterns for an illumination layer for an example mixed reality system, according to one or more embodiments of the disclosure.

FIGS. 18A-18I illustrate examples of out-coupling gratings for an illumination layer for an example mixed reality system, according to one or more embodiments of the disclosure.

FIGS. 19A-19C illustrate examples of outputted light from an illumination layer for an example mixed reality system, according to one or more embodiments of the disclosure.

FIGS. 20A-20C illustrate examples of outputted light from an illumination layer for an example mixed reality system, according to one or more embodiments of the disclosure.

FIG. 21 illustrates a process for manufacturing illumination layers for an example mixed reality system, according to one or more embodiments of the disclosure.

FIG. 22 illustrates a block diagram of a process for manufacturing illumination layers for an example mixed reality system, according to one or more embodiments of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

### Mixed Reality Environment

Like all people, a user of a mixed reality system exists in a real environment—that is, a three-dimensional portion of the “real world,” and all of its contents, that are perceptible by the user. For example, a user perceives a real environment using one's ordinary human senses—sight, sound, touch, taste, smell—and interacts with the real environment by moving one's own body in the real environment. Locations in a real environment can be described as coordinates in a coordinate space; for example, a coordinate can comprise latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time t0, based on data associated with the virtual environment and/or input provided by a user, a state of the virtual environment at a second time t1. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time t1. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include only some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate—for instance, an audio signal corresponding to a composite of sounds in the virtual environment, and mixed and processed to simulate an audio signal that would be heard by a listener at the listener coordinate—and present the audio signal to a user via one or more speakers.

Because a virtual environment exists only as a computational structure, a user cannot directly perceive a virtual environment using one's ordinary senses. Instead, a user can perceive a virtual environment only indirectly, as presented to the user, for example by a display, speakers, haptic output devices, etc. Similarly, a user cannot directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A mixed reality system can present to the user, for example using a transmissive display and/or one or more speakers (which may, for example, be incorporated into a wearable head device), a mixed reality environment (“MRE”) that combines aspects of a real environment and a virtual environment. In some embodiments, the one or more speakers may be external to the head-mounted wearable unit. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE comprises a real lamp post (a real object) at a location coordinate, the virtual environment of the MRE may comprise a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may comprise a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may comprise a green, two-armed cactus—a prickly inanimate object—a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment—because, as noted above, a user cannot directly perceive or interact with a virtual environment—a user of an MR system may find it intuitive and natural to interact with a virtual object by seeing, hearing, and touching a corresponding real object in his or her own real environment. This level of interactivity can heighten a user's feelings of immersion, connection, and engagement with a virtual environment. Similarly, by simultaneously presenting a real environment and a virtual environment, mixed reality systems can reduce negative psychological feelings (e.g., cognitive dissonance) and negative physical feelings (e.g., motion sickness) associated with VR systems. Mixed reality systems further offer many possibilities for applications that may augment or alter our experiences of the real world.

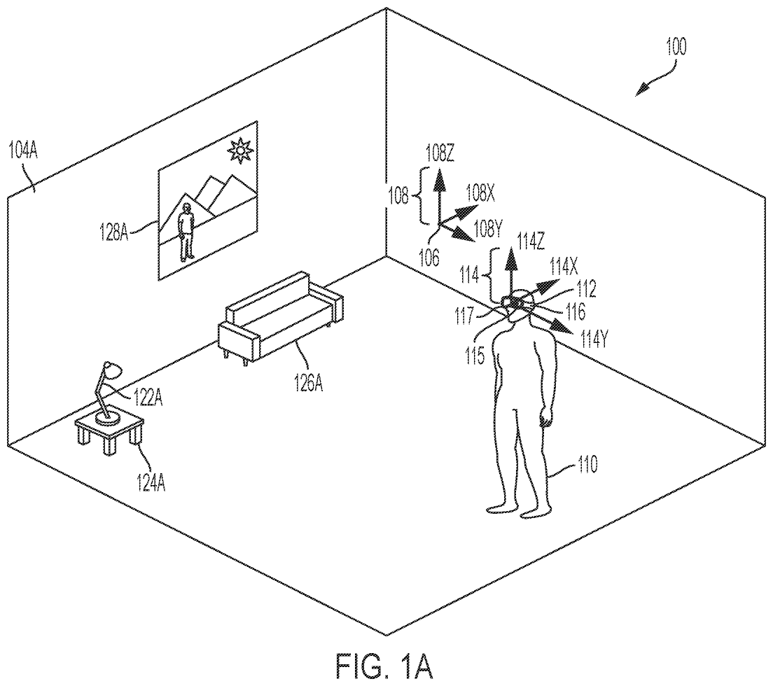

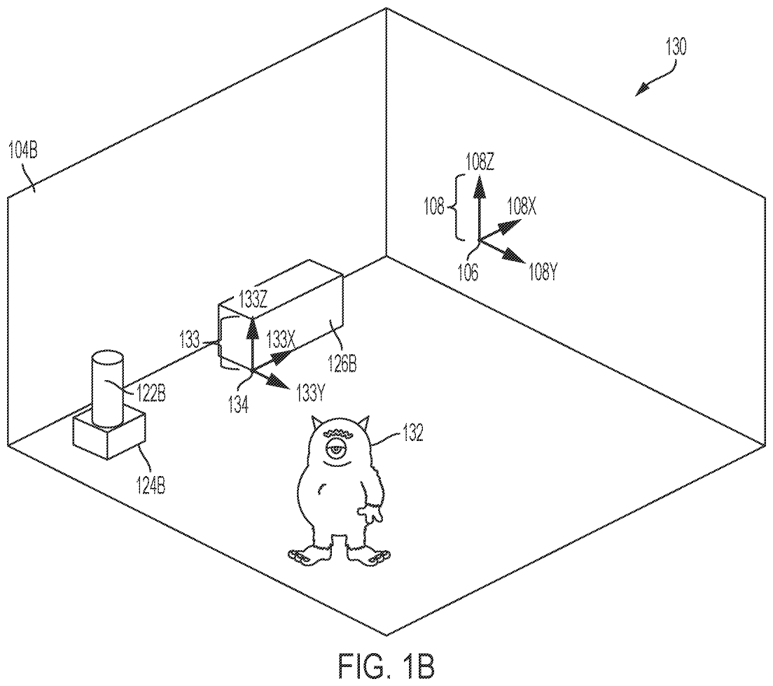

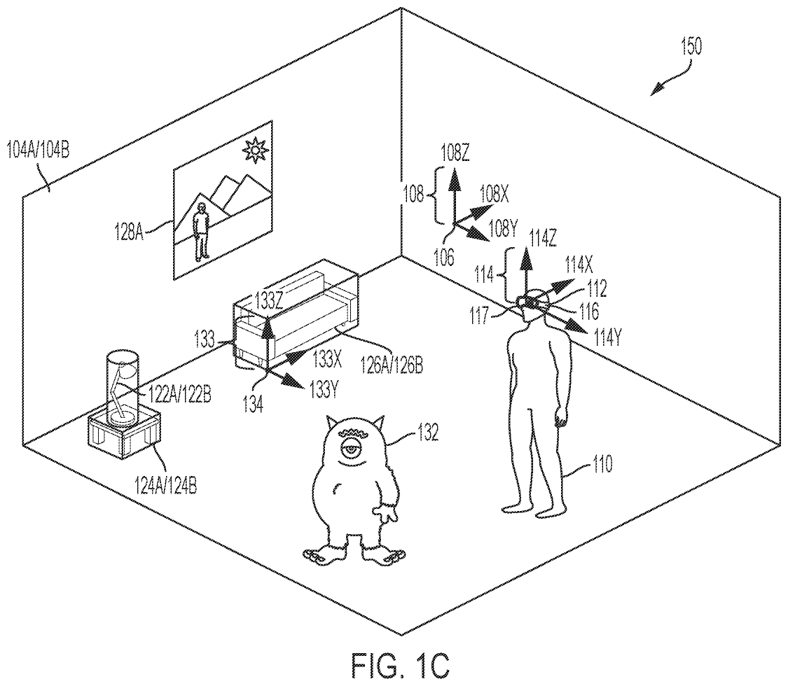

FIG. 1A illustrates an example real environment 100 in which a user 110 uses a mixed reality system 112. Mixed reality system 112 may comprise a display (e.g., a transmissive display) and one or more speakers, and one or more sensors (e.g., a camera), for example as described below. The real environment 100 shown comprises a rectangular room 104A, in which user 110 is standing; and real objects 122A (a lamp), 124A (a table), 126A (a sofa), and 128A (a painting). Room 104A further comprises a location coordinate 106, which may be considered an origin of the real environment 100. As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a Quaternion matrix or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a Quaternion matrix or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an example virtual environment 130 that corresponds to real environment 100. The virtual environment 130 shown comprises a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, and 126A. Virtual environment 130 additionally comprises a virtual monster 132, which does not correspond to any real object in real environment 100. Real object 128A in real environment 100 does not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a Quaternion matrix or other rotation matrix), or other suitable representation can characterize a transformation between the persistent coordinate system 133 space and the environment/world coordinate system 108 space. In some embodiments, each of the virtual objects 122B, 124B, 126B, and 132 may have their own persistent coordinate point relative to the origin point 134 of the persistent coordinate system 133. In some embodiments, there may be multiple persistent coordinate systems and each of the virtual objects 122B, 124B, 126B, and 132 may have their own persistent coordinate point relative to one or more persistent coordinate systems.

Persistent coordinate data may be coordinate data that persists relative to a physical environment. Persistent coordinate data may be used by MR systems (e.g., MR system 112, 200) to place persistent virtual content, which may not be tied to movement of a display on which the virtual object is being displayed. For example, a two-dimensional screen may only display virtual objects relative to a position on the screen. As the two-dimensional screen moves, the virtual content may move with the screen. In some embodiments, persistent virtual content may be displayed in a corner of a room. A MR user may look at the corner, see the virtual content, look away from the corner (where the virtual content may no longer be visible because the virtual content may have moved from within the user's field of view to a location outside the user's field of view due to motion of the user's head), and look back to see the virtual content in the corner (similar to how a real object may behave).

In some embodiments, persistent coordinate data (e.g., a persistent coordinate system and/or a persistent coordinate frame) can include an origin point and three axes. For example, a persistent coordinate system may be assigned to a center of a room by a MR system. In some embodiments, a user may move around the room, out of the room, re-enter the room, etc., and the persistent coordinate system may remain at the center of the room (e.g., because it persists relative to the physical environment). In some embodiments, a virtual object may be displayed using a transform to persistent coordinate data, which may enable displaying persistent virtual content. In some embodiments, a MR system may use simultaneous localization and mapping to generate persistent coordinate data (e.g., the MR system may assign a persistent coordinate system to a point in space). In some embodiments, a MR system may map an environment by generating persistent coordinate data at regular intervals (e.g., a MR system may assign persistent coordinate systems in a grid where persistent coordinate systems may be at least within five feet of another persistent coordinate system).

In some embodiments, persistent coordinate data may be generated by a MR system and transmitted to a remote server. In some embodiments, a remote server may be configured to receive persistent coordinate data. In some embodiments, a remote server may be configured to synchronize persistent coordinate data from multiple observation instances. For example, multiple MR systems may map the same room with persistent coordinate data and transmit that data to a remote server. In some embodiments, the remote server may use this observation data to generate canonical persistent coordinate data, which may be based on the one or more observations. In some embodiments, canonical persistent coordinate data may be more accurate and/or reliable than a single observation of persistent coordinate data. In some embodiments, canonical persistent coordinate data may be transmitted to one or more MR systems. For example, a MR system may use image recognition and/or location data to recognize that it is located in a room that has corresponding canonical persistent coordinate data (e.g., because other MR systems have previously mapped the room). In some embodiments, the MR system may receive canonical persistent coordinate data corresponding to its location from a remote server.

With respect to FIGS. 1A and 1B, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a Quaternion matrix or other rotation matrix), or other suitable representation can characterize a transformation between a real environment coordinate space and a virtual environment coordinate space.

FIG. 1C illustrates an example MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As above, origin point 106 acts as an origin for a coordinate space corresponding to MRE 150, and coordinate system 108 defines an x-axis, y-axis, and z-axis for the coordinate space.

In the example shown, mixed reality objects comprise corresponding pairs of real objects and virtual objects (i.e., 122A/122B, 124A/124B, 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described above may also incorporate audio aspects. For instance, in MRE 150, virtual monster 132 could be associated with one or more audio signals, such as a footstep sound effect that is generated as the monster walks around MRE 150. As described further below, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

### Example Mixed Reality System

Example mixed reality system 112 can include a wearable head device (e.g., a wearable augmented reality or mixed reality head device) comprising a display (which may comprise left and right transmissive displays, which may be near-eye displays, and associated components for coupling light from the displays to the user's eyes); left and right speakers (e.g., positioned adjacent to the user's left and right ears, respectively); an inertial measurement unit (IMU)(e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability) to communicate with other devices and systems, including other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described further below.

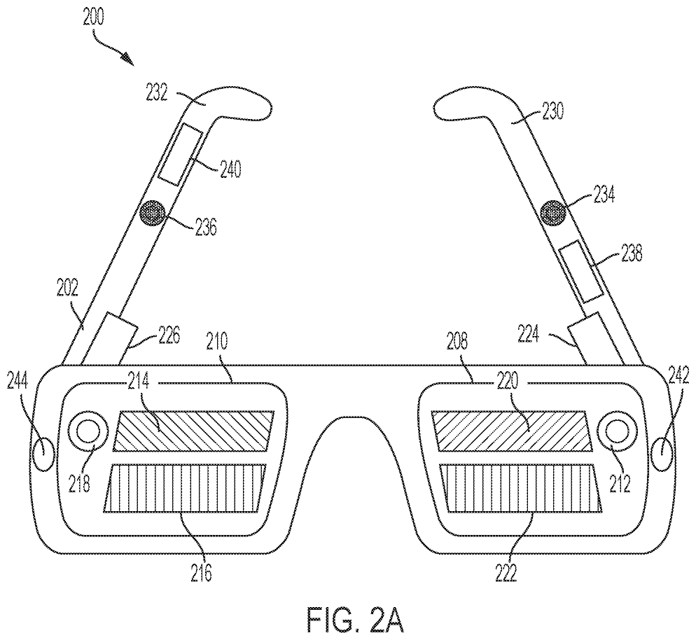

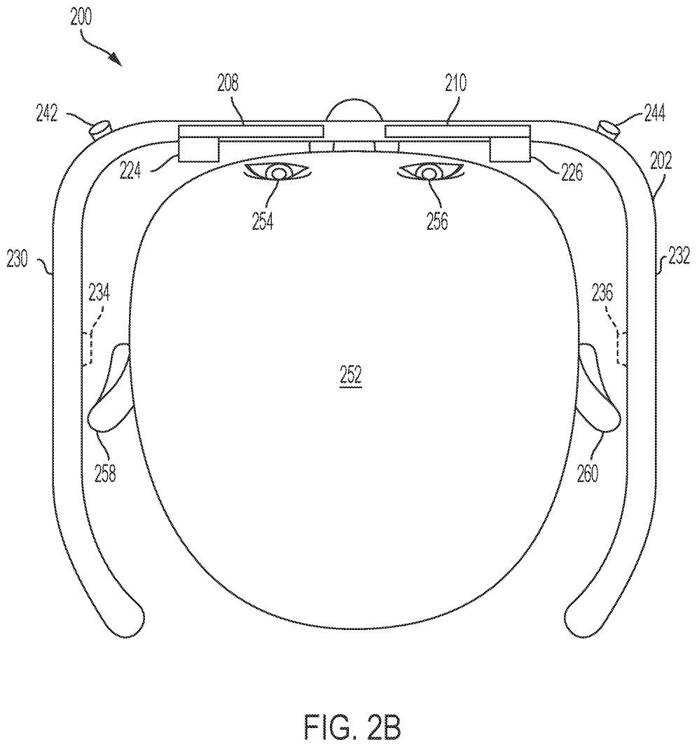

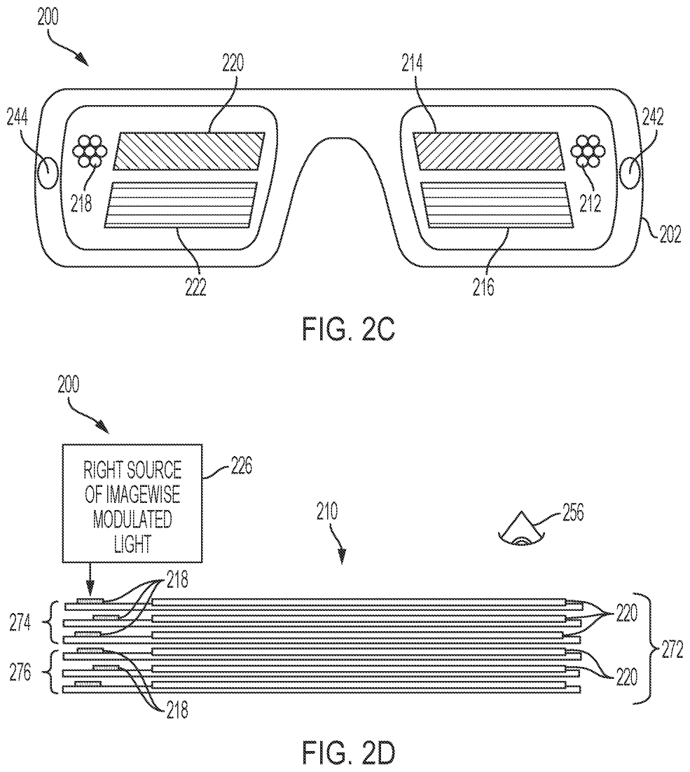

FIGS. 2A-2D illustrate components of an example mixed reality system 200 (which may correspond to mixed reality system 112) that may be used to present a MRE (which may correspond to MRE 150), or other virtual environment, to a user. FIG. 2A illustrates a perspective view of a wearable head device 202 included in example mixed reality system 200. FIG. 2B illustrates a top view of wearable head device 202 worn on a user's head 252. FIG. 2C illustrates a front view of wearable head device 202. FIG. 2D illustrates an edge view of example eyepiece 210 of wearable head device 202. As shown in FIGS. 2A-2C, the example wearable head device 202 includes an example left eyepiece (e.g., a left transparent waveguide set eyepiece) 208 and an example right eyepiece (e.g., a right transparent waveguide set eyepiece) 210. Each eyepiece 208 and 210 can include transmissive elements through which a real environment can be visible, as well as display elements for presenting a display (e.g., via imagewise modulated light) overlapping the real environment. In some examples, such display elements can include surface diffractive optical elements for controlling the flow of imagewise modulated light. For instance, the left eyepiece 208 can include a left in-coupling grating set 212, a left orthogonal pupil expansion (OPE) grating set 220, and a left exit (output) pupil expansion (EPE) grating set 222. As used herein, a pupil may refer to the exit of light from an optical element such as a grating set or reflector. Similarly, the right eyepiece 210 can include a right in-coupling grating set 218, a right OPE grating set 214 and a right EPE grating set 216. Imagewise modulated light can be transferred to a user's eye via the in-coupling gratings 212 and 218, OPEs 214 and 220, and EPE 216 and 222. Each in-coupling grating set 212, 218 can be configured to deflect light toward its corresponding OPE grating set 220, 214. Each OPE grating set 220, 214 can be designed to incrementally deflect light down toward its associated EPE 222, 216, thereby horizontally extending an exit pupil being formed. Each EPE 222, 216 can be configured to incrementally redirect at least a portion of light received from its corresponding OPE grating set 220, 214 outward to a user eyebox position (not shown) defined behind the eyepieces 208, 210, vertically extending the exit pupil that is formed at the eyebox. Alternatively, in lieu of the in-coupling grating sets 212 and 218, OPE grating sets 214 and 220, and EPE grating sets 216 and 222, the eyepieces 208 and 210 can include other arrangements of gratings and/or refractive and reflective features for controlling the coupling of imagewise modulated light to the user's eyes.

In some examples, wearable head device 202 can include a left temple arm 230 and a right temple arm 232, where the left temple arm 230 includes a left speaker 234 and the right temple arm 232 includes a right speaker 236. An orthogonal coil electromagnetic receiver 238 can be located in the left temple piece, or in another suitable location in the wearable head unit 202. An Inertial Measurement Unit (IMU) 240 can be located in the right temple arm 232, or in another suitable location in the wearable head device 202. The wearable head device 202 can also include a left depth (e.g., time-of-flight) camera 242 and a right depth camera 244. The depth cameras 242, 244 can be suitably oriented in different directions so as to together cover a wider field of view.

In the example shown in FIGS. 2A-2D, a left source of imagewise modulated light 224 can be optically coupled into the left eyepiece 208 through the left in-coupling grating set 212, and a right source of imagewise modulated light 226 can be optically coupled into the right eyepiece 210 through the right in-coupling grating set 218. Sources of imagewise modulated light 224, 226 can include, for example, optical fiber scanners; projectors including electronic light modulators such as Digital Light Processing (DLP) chips or Liquid Crystal on Silicon (LCoS) modulators; or emissive displays, such as micro Light Emitting Diode (μLED) or micro Organic Light Emitting Diode (μOLED) panels coupled into the in-coupling grating sets 212, 218 using one or more lenses per side. The input coupling grating sets 212, 218 can deflect light from the sources of imagewise modulated light 224, 226 to angles above the critical angle for Total Internal Reflection (TIR) for the eyepieces 208, 210. The OPE grating sets 214, 220 incrementally deflect light propagating by TIR down toward the EPE grating sets 216, 222. The EPE grating sets 216, 222 incrementally couple light toward the user's face, including the pupils of the user's eyes.

In some examples, as shown in FIG. 2D, each of the left eyepiece 208 and the right eyepiece 210 includes a plurality of waveguides 272. For example, each eyepiece 208, 210 can include multiple individual waveguides, each dedicated to a respective color channel (e.g., red, blue and green). In some examples, each eyepiece 208, 210 can include multiple sets of such waveguides, with each set configured to impart different wavefront curvature to emitted light. The wavefront curvature may be convex with respect to the user's eyes, for example to present a virtual object positioned a distance in front of the user (e.g., by a distance corresponding to the reciprocal of wavefront curvature). In some examples, EPE grating sets 216, 222 can include curved grating grooves to effect convex wavefront curvature by altering the Poynting vector of exiting light across each EPE.

In some examples, to create a perception that displayed content is three-dimensional, stereoscopically-adjusted left and right eye imagery can be presented to the user through the imagewise light modulators 224, 226 and the eyepieces 208, 210. The perceived realism of a presentation of a three-dimensional virtual object can be enhanced by selecting waveguides (and thus corresponding the wavefront curvatures) such that the virtual object is displayed at a distance approximating a distance indicated by the stereoscopic left and right images. This technique may also reduce motion sickness experienced by some users, which may be caused by differences between the depth perception cues provided by stereoscopic left and right eye imagery, and the autonomic accommodation (e.g., object distance-dependent focus) of the human eye.

FIG. 2D illustrates an edge-facing view from the top of the right eyepiece 210 of example wearable head device 202. As shown in FIG. 2D, the plurality of waveguides 272 can include a first subset of three waveguides 274 and a second subset of three waveguides 276. The two subsets of waveguides 274, 276 can be differentiated by different EPE gratings featuring different grating line curvatures to impart different wavefront curvatures to exiting light. Within each of the subsets of waveguides 274, 2476 each waveguide can be used to couple a different spectral channel (e.g., one of red, green and blue spectral channels) to the user's right eye 256. (Although not shown in FIG. 2D, the structure of the left eyepiece 208 is analogous to the structure of the right eyepiece 210.)

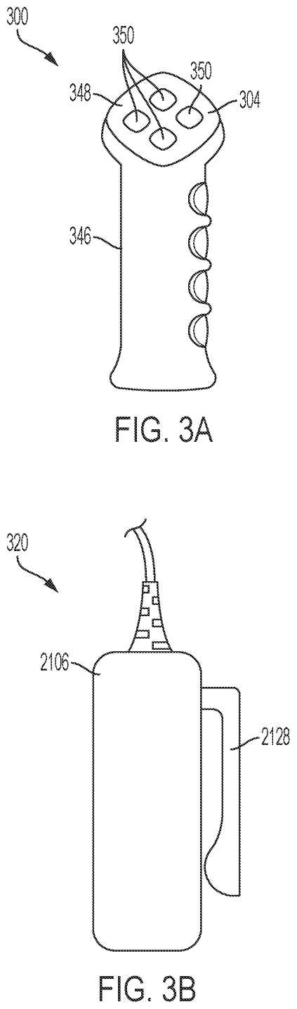

FIG. 3A illustrates an example handheld controller component 300 of a mixed reality system 200. In some examples, handheld controller 300 includes a grip portion 346 and one or more buttons 350 disposed along a top surface 348. In some examples, buttons 350 may be configured for use as an optical tracking target, e.g., for tracking six-degree-of-freedom (6DOF) motion of the handheld controller 300, in conjunction with a camera or other optical sensor (which may be mounted in a head unit (e.g., wearable head device 202) of mixed reality system 200). In some examples, handheld controller 300 includes tracking components (e.g., an IMU or other suitable sensors) for detecting position or orientation, such as position or orientation relative to wearable head device 202. In some examples, such tracking components may be positioned in a handle of handheld controller 300, and/or may be mechanically coupled to the handheld controller. Handheld controller 300 can be configured to provide one or more output signals corresponding to one or more of a pressed state of the buttons; or a position, orientation, and/or motion of the handheld controller 300 (e.g., via an IMU). Such output signals may be used as input to a processor of mixed reality system 200. Such input may correspond to a position, orientation, and/or movement of the handheld controller (and, by extension, to a position, orientation, and/or movement of a hand of a user holding the controller). Such input may also correspond to a user pressing buttons 350.

FIG. 3B illustrates an example auxiliary unit 320 of a mixed reality system 200. The auxiliary unit 320 can include a battery to provide energy to operate the system 200, and can include a processor for executing programs to operate the system 200. As shown, the example auxiliary unit 320 includes a clip 228, such as for attaching the auxiliary unit 320 to a user's belt. Other form factors are suitable for auxiliary unit 320 and will be apparent, including form factors that do not involve mounting the unit to a user's belt. In some examples, auxiliary unit 320 is coupled to the wearable head device 202 through a multiconduit cable that can include, for example, electrical wires and fiber optics. Wireless connections between the auxiliary unit 320 and the wearable head device 202 can also be used.

In some examples, mixed reality system 200 can include one or more microphones to detect sound and provide corresponding signals to the mixed reality system. In some examples, a microphone may be attached to, or integrated with, wearable head device 202, and may be configured to detect a user's voice. In some examples, a microphone may be attached to, or integrated with, handheld controller 300 and/or auxiliary unit 320. Such a microphone may be configured to detect environmental sounds, ambient noise, voices of a user or a third party, or other sounds.

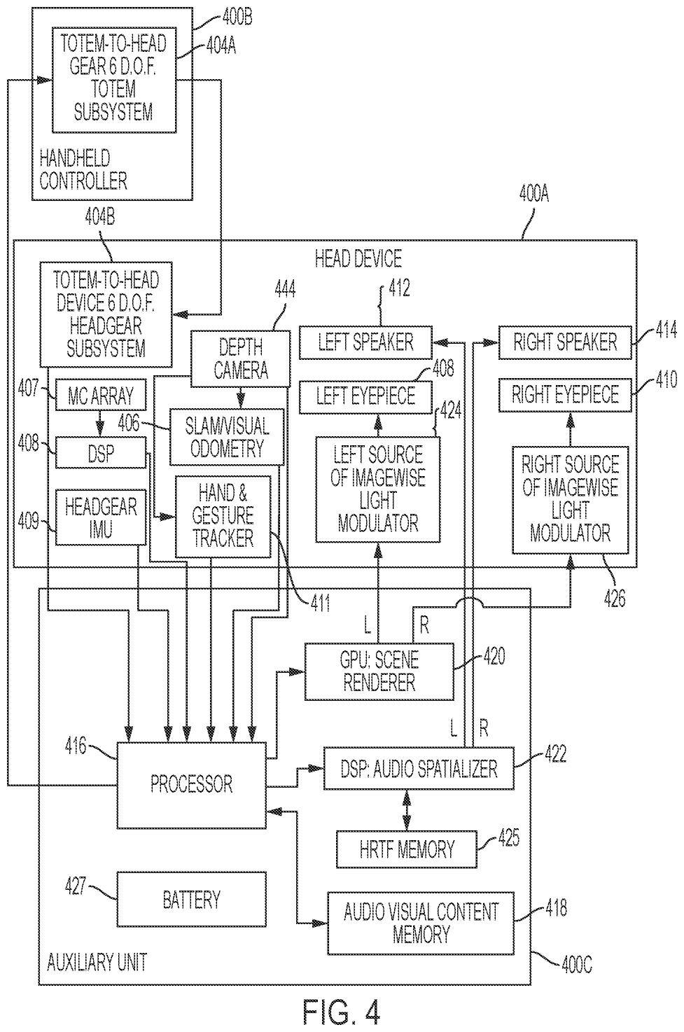

FIG. 4 shows an example functional block diagram that may correspond to an example mixed reality system, such as mixed reality system 200 described above (which may correspond to mixed reality system 112 with respect to FIG. 1). As shown in FIG. 4, example handheld controller 400B (which may correspond to handheld controller 300 (a “totem”)) includes a totem-to-wearable head device six degree of freedom (6DOF) totem subsystem 404A and example wearable head device 400A (which may correspond to wearable head device 202) includes a totem-to-wearable head device 6DOF subsystem 404B. In the example, the 6DOF totem subsystem 404A and the 6DOF subsystem 404B cooperate to determine six coordinates (e.g., offsets in three translation directions and rotation along three axes) of the handheld controller 400B relative to the wearable head device 400A. The six degrees of freedom may be expressed relative to a coordinate system of the wearable head device 400A. The three translation offsets may be expressed as X, Y, and Z offsets in such a coordinate system, as a translation matrix, or as some other representation. The rotation degrees of freedom may be expressed as sequence of yaw, pitch and roll rotations, as a rotation matrix, as a quaternion, or as some other representation. In some examples, the wearable head device 400A; one or more depth cameras 444 (and/or one or more non-depth cameras) included in the wearable head device 400A; and/or one or more optical targets (e.g., buttons 350 of handheld controller 400B as described above, or dedicated optical targets included in the handheld controller 400B) can be used for 6DOF tracking. In some examples, the handheld controller 400B can include a camera, as described above; and the wearable head device 400A can include an optical target for optical tracking in conjunction with the camera. In some examples, the wearable head device 400A and the handheld controller 400B each include a set of three orthogonally oriented solenoids which are used to wirelessly send and receive three distinguishable signals. By measuring the relative magnitude of the three distinguishable signals received in each of the coils used for receiving, the 6DOF of the wearable head device 400A relative to the handheld controller 400B may be determined. Additionally, 6DOF totem subsystem 404A can include an Inertial Measurement Unit (IMU) that is useful to provide improved accuracy and/or more timely information on rapid movements of the handheld controller 400B.

In some embodiments, wearable system 400 can include microphone array 407, which can include one or more microphones arranged on headgear device 400A. In some embodiments, microphone array 407 can include four microphones. Two microphones can be placed on a front face of headgear 400A, and two microphones can be placed at a rear of head headgear 400A (e.g., one at a back-left and one at a back-right). In some embodiments, signals received by microphone array 407 can be transmitted to DSP 408. DSP 408 can be configured to perform signal processing on the signals received from microphone array 407. For example, DSP 408 can be configured to perform noise reduction, acoustic echo cancellation, and/or beamforming on signals received from microphone array 407. DSP 408 can be configured to transmit signals to processor 416.

In some examples, it may become necessary to transform coordinates from a local coordinate space (e.g., a coordinate space fixed relative to the wearable head device 400A) to an inertial coordinate space (e.g., a coordinate space fixed relative to the real environment), for example in order to compensate for the movement of the wearable head device 400A relative to the coordinate system 108. For instance, such transformations may be necessary for a display of the wearable head device 400A to present a virtual object at an expected position and orientation relative to the real environment (e.g., a virtual person sitting in a real chair, facing forward, regardless of the wearable head device's position and orientation), rather than at a fixed position and orientation on the display (e.g., at the same position in the right lower corner of the display), to preserve the illusion that the virtual object exists in the real environment (and does not, for example, appear positioned unnaturally in the real environment as the wearable head device 400A shifts and rotates). In some examples, a compensatory transformation between coordinate spaces can be determined by processing imagery from the depth cameras 444 using a SLAM and/or visual odometry procedure in order to determine the transformation of the wearable head device 400A relative to the coordinate system 108. In the example shown in FIG. 4, the depth cameras 444 are coupled to a SLAM/visual odometry block 406 and can provide imagery to block 406. The SLAM/visual odometry block 406 implementation can include a processor configured to process this imagery and determine a position and orientation of the user's head, which can then be used to identify a transformation between a head coordinate space and another coordinate space (e.g., an inertial coordinate space). Similarly, in some examples, an additional source of information on the user's head pose and location is obtained from an IMU 409. Information from the IMU 409 can be integrated with information from the SLAM/visual odometry block 406 to provide improved accuracy and/or more timely information on rapid adjustments of the user's head pose and position.

In some examples, the depth cameras 444 can supply 3D imagery to a hand gesture tracker 411, which may be implemented in a processor of the wearable head device 400A. The hand gesture tracker 411 can identify a user's hand gestures, for example by matching 3D imagery received from the depth cameras 444 to stored patterns representing hand gestures. Other suitable techniques of identifying a user's hand gestures will be apparent.

In some examples, one or more processors 416 may be configured to receive data from the wearable head device's 6DOF headgear subsystem 404B, the IMU 409, the SLAM/visual odometry block 406, depth cameras 444, and/or the hand gesture tracker 411. The processor 416 can also send and receive control signals from the 6DOF totem system 404A. The processor 416 may be coupled to the 6DOF totem system 404A wirelessly, such as in examples where the handheld controller 400B is untethered. Processor 416 may further communicate with additional components, such as an audio-visual content memory 418, a Graphical Processing Unit (GPU) 420, and/or a Digital Signal Processor (DSP) audio spatializer 422. The DSP audio spatializer 422 may be coupled to a Head Related Transfer Function (HRTF) memory 425. The GPU 420 can include a left channel output coupled to the left source of imagewise modulated light 424 and a right channel output coupled to the right source of imagewise modulated light 426. GPU 420 can output stereoscopic image data to the sources of imagewise modulated light 424, 426, for example as described above with respect to FIGS. 2A-2D. The DSP audio spatializer 422 can output audio to a left speaker 412 and/or a right speaker 414. The DSP audio spatializer 422 can receive input from processor 419 indicating a direction vector from a user to a virtual sound source (which may be moved by the user, e.g., via the handheld controller 320). Based on the direction vector, the DSP audio spatializer 422 can determine a corresponding HRTF (e.g., by accessing a HRTF, or by interpolating multiple HRTFs). The DSP audio spatializer 422 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment—that is, by presenting a virtual sound that matches a user's expectations of what that virtual sound would sound like if it were a real sound in a real environment.

In some examples, such as shown in FIG. 4, one or more of processor 416, GPU 420, DSP audio spatializer 422, HRTF memory 425, and audio/visual content memory 418 may be included in an auxiliary unit 400C (which may correspond to auxiliary unit 320 described above). The auxiliary unit 400C may include a battery 427 to power its components and/or to supply power to the wearable head device 400A or handheld controller 400B. Including such components in an auxiliary unit, which can be mounted to a user's waist, can limit the size and weight of the wearable head device 400A, which can in turn reduce fatigue of a user's head and neck.

While FIG. 4 presents elements corresponding to various components of an example mixed reality system, various other suitable arrangements of these components will become apparent to those skilled in the art. For example, elements presented in FIG. 4 as being associated with auxiliary unit 400C could instead be associated with the wearable head device 400A or handheld controller 400B. Furthermore, some mixed reality systems may forgo entirely a handheld controller 400B or auxiliary unit 400C. Such changes and modifications are to be understood as being included within the scope of the disclosed examples.

### Example Thin Waveguide Illumination Layer

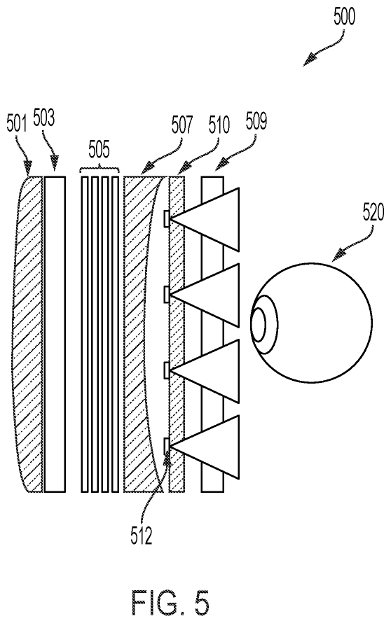

A wearable head device or head mounted display of an example mixed reality system (e.g., mixed reality system 200) may include an optical system for presenting an image to a user via the display. The example optical system may further include eye-tracking capabilities. For example, FIGS. 5, 6A-6B, 7A-7D, 8A-8C, and 9A-9C illustrate examples of an optical system and/or illumination layer that can be used in a wearable head device (e.g., wearable head device 202) according to embodiments of this disclosure.

FIG. 5 illustrates an optical stack corresponding to an example optical system 500 that may be used in a wearable head device (e.g., wearable head device 202). As shown in the figure, the optical system 500 can include a plurality of optical components arranged in layers. For example, the optical system 500 may include one or more of an outer lens 501, a dimmer 503, a visible light waveguide 505, an inner lens 507, an IR illumination layer 510, and a corrective prescription insert 509. The optical system 500 may be configured to present a digital image to the eye 520 of a user, present a view of the user's environment, and/or track movement of the user's eye. The outer lens and inner lens may provide a view of the user's environment and/or digital image that is in focus. In some examples, the outer lens 501 and/or inner lens 507 can be mounted to a carrier plate (not separately shown) for rigidity, e.g., so that the lenses can maintain their shape. The dimmer 503 can be provided to adjust the amount of light that enters the optical system from the user's environment. The visible light waveguide 505 can be provided to present digital content to a user. The IR illumination layer 510 (also referred to herein as an illumination layer) can be provided to facilitate eye-tracking capabilities. In some examples, the illumination layer can be positioned between the visible light waveguide 505 and the user's eye. The corrective prescription insert 509 may be provided to tailor the optical system to a specific user's eyesight. The drawings are included for illustrative purposes and may not necessarily be to scale and/or indicate the relative thickness of the layers.

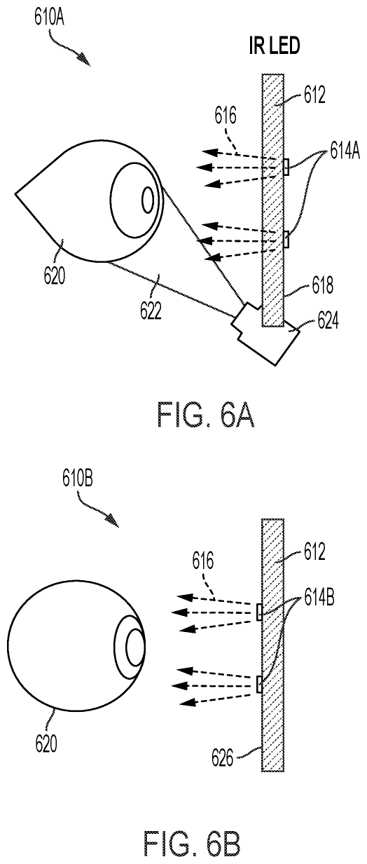

FIG. 6A illustrates an example illumination layer 610A according to embodiments of this disclosure. The illumination layer 610A may be included in an optical system, e.g., optical system 500. As shown in the figure, the illumination layer 610A may include a substrate 612 and one or more LEDs 614A. In some embodiments, the illumination layer may include one or more metal traces (not shown) that are connected to the one or more LEDs 614A. The LEDs 614A may be IR LEDs that correspond to a wavelength in the infrared range. As shown in the figure, the one or more LEDs 614A may be disposed on a back surface 618 of the substrate 612. The LEDs 614A may provide IR illumination light 616 to the eye 620 of a user. The IR illumination light may be reflected off the surface of the eye 620 to form IR eye reflected light 622, e.g., eye glint. A portion of the IR reflected light 622 may be received at a light sensor 624. In some embodiments, the light sensor 624 may be located near an outer edge of the illumination layer 610A, e.g., at an edge of the optical system 500. In some examples, the light sensor 624 may be a part of the optical system but not be physically disposed on the illumination layer. The received portion of the IR reflected light 622, e.g., eye glint, can be processed by the MR system to track eye movement of the eye 620.

FIG. 6B illustrates an example illumination layer 610B according to embodiments of this disclosure. The illumination layer 610B may be included in an optical system, e.g., optical system 500. As shown in the figure, the illumination layer 610B may include a substrate 612 and one or more LEDs 614B. As shown in the figure, the one or more LEDs 614B may be disposed on a front surface 626 of the substrate 612. In some embodiments, the illumination layer may include one or more metal traces (not shown) that are connected to the one or more LEDs 614B. The LEDs 614B may provide IR illumination light 616 to the eye of a user as discussed with respect to FIG. 6A. The LEDs 614B may be IR LEDs that correspond to a wavelength in the infrared range.

In some embodiments, the substrate 612 may be a flexible or rigid substrate formed from a polymer layer laminated on a carrier plate, e.g., glass carrier plate. For example, the substrate may include a polycarbonate (PC), polyethylene terephthalate (PET), and/or triacetate cellulose (TAC) laminated on a glass carrier plate. While the polymer materials forming the substrate 612 may be relatively inexpensive and mechanically reliable, the substrate 612 may be prone to light transmission loss due to reflection and/or haze, as well as light transmission loss at the interface between materials, e.g., at the polymer/glass interface. Moreover, polymer materials can be prone to processing issues such as surface chemical attack and swelling, and be less scratch resistant, which all can contribute to reduced light transmission and increased haze. The loss of light transmission and haze can affect the amount of environment light that passes through the optical system, e.g., optical system 500, and impact the quality of the digital image presented to the user via the optical system.

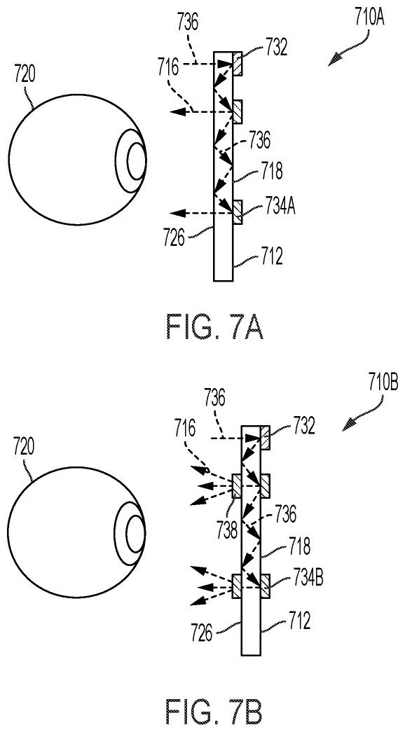

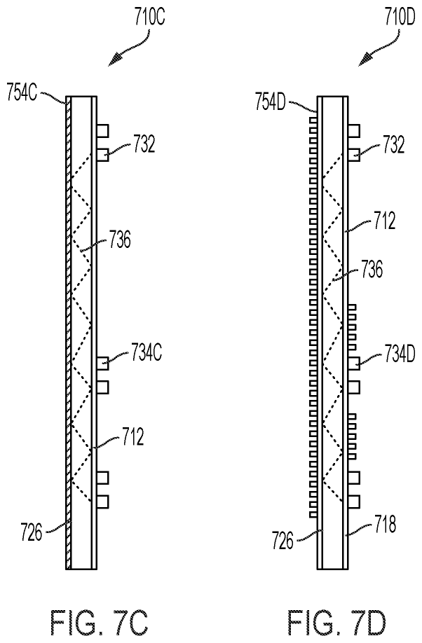

In one or more embodiments of this disclosure, the illumination layer can comprise a thin waveguide. In some examples, a waveguide illumination layer according to embodiments of this disclosure can be thinner than an LED illumination layer. FIGS. 7A and 7B illustrate examples of a waveguide illumination layer according to embodiments of this disclosure. As shown in the FIG. 7A, the illumination layer 710A may include a waveguide 712. The waveguide may include at least an in-coupling grating 732 and one or more out-coupling gratings 734. The in-coupling grating 732 can be provided to receive and in-couple light 736 into the waveguide 712. The one or more out-coupling gratings 734 can be provided to couple light 716 out of the waveguide 712. As shown in the figure, both the in-coupling grating 712 and the one or more out-coupling gratings 734A can be disposed on the same surface 718, e.g., a back surface 718 of the waveguide 712, away from an eye 720 of a user. In some embodiments, both the in-coupling grating 712 and the one or more out-coupling gratings 734A can be disposed on a front surface 726 of the waveguide, towards the eye 720 of the user. In one or more examples, the in-coupling grating and the out-coupling gratings can be disposed on opposite faces. For example, the in-coupling grating can be disposed on the back surface, while the out-coupling grating can be disposed on a front surface.

As shown in the figure, the in-coupling grating 732, can receive light 736 from a LED, e.g., an external IR LED. In some examples, the waveguide 712 can be positioned such that the in-coupling grating 732 is aligned with an LED external to the illumination layer 710A of the optical system. The received light 736 can pass through the waveguide and be in-coupled into the waveguide 712 by the in-coupling grating 732 disposed on the back surface 718 of the waveguide 712. The in-coupled light can be reflected within the waveguide 712 via total internal reflection (TIR) to form internally reflected light 736.

The one or more out-coupling gratings 734A can receive the reflected light 736 via TIR and out-couple the reflected light out of the waveguide 712 to form out-coupled light 716. The out-coupled light 716 can be directed toward an eye of a user. In some examples, The IR illumination light may be reflected off the surface of the eye to form IR eye reflected light (eye glint) that can be used to track eye movements as discussed above. In some examples, the one or more out-coupling gratings 734A can be positioned in small specific region of the waveguide 712. For example, the one or more out-coupling gratings 734A can have a diameter of about 0.5 mm. In some examples, the one or more out-coupling gratings can out-couple light 716 at a high efficiency and intensity to direct one or more of out-coupled light 716 to the eye for eye tracking.

FIG. 7B illustrates an example of a waveguide illumination layer according to embodiments of this disclosure. As shown in the figure, the illumination layer 710B may be substantially similar to illumination layer 710A. For example, illumination layer can include a waveguide 712, where the waveguide 712 can include at least an in-coupling grating 732 and one or more out-coupling gratings 734B, as discussed above. As shown in the figure, the out-coupling gratings 734B can be disposed on both the front and back surfaces of the waveguide 712. The in-coupling gratings 732 and out-coupling gratings 734B may function similarly to the gratings discussed with respect to illumination layer 710A.

Waveguide illumination layers according to embodiments of this disclosure may not suffer from the haze and light loss associated with LED illumination layers, e.g., illumination layers 610A-610B. For example, the waveguide illumination layers need not exhibit light loss associated with light traveling between a polymer and glass carrier plate because the waveguide illumination layer 710 can comprise waveguide layer 712 with one or more gratings disposed thereon. In one or more examples, in order to improve transmittance of visible light through the waveguide illumination layer, one or more antireflective layers can be applied to at least one surface of the waveguide as illustrated in FIGS. 7C-7D.

FIG. 7C illustrates an example of a waveguide illumination layer 710C according to embodiments of this disclosure. As shown in the figure, the waveguide illumination layer 710C may be substantially similar to waveguide illumination layer 710A. For example, illumination layer 710C can include a waveguide 712, where the waveguide 712 can include at least an in-coupling grating 732 and one or more out-coupling gratings 734C. The waveguide illumination layer 710C can further include an antireflective coating 754C disposed on a front surface 726 of the waveguide 712. As discussed above, the antireflective coating 754C can improve the transmittance of the waveguide illumination layer 710C to visible light.

FIG. 7D illustrates an example of a waveguide illumination layer 710D according to embodiments of this disclosure. As shown in the figure, the waveguide illumination layer 710D may be substantially similar to waveguide illumination layer 710A. For example, illumination layer 710D can include a waveguide 712, where the waveguide 712 can include at least an in-coupling grating 732 and one or more out-coupling gratings 734D. The waveguide illumination layer 710D can further include an antireflective layer 754D disposed on a front surface 726 of the waveguide 712. The antireflective nano-pattern can include a plurality of nano-structures that form a surface relief (SR) pattern on one or more surfaces of the waveguide 710D. In some examples, the antireflective nano-pattern 754D can be applied to one or both faces of the waveguide. As shown in the figure, for example, the antireflective nano-pattern 754D can be patterned across the front face 726 of the waveguide 710D. As shown in the figure, for example, the nano-pattern 754D can be patterned across the rear face 718 of the waveguide 710D, between the one or more out-coupling gratings 734D. Antireflective nano-patterns are, for example, as discussed in greater detail in U.S. Provisional Patent Application No. 63/176,077, filed Apr. 16, 2021, which is hereby incorporated by reference in its entirety. As discussed above, the antireflective coating 754D can improve the transmittance of the waveguide illumination layer 710D to visible light.

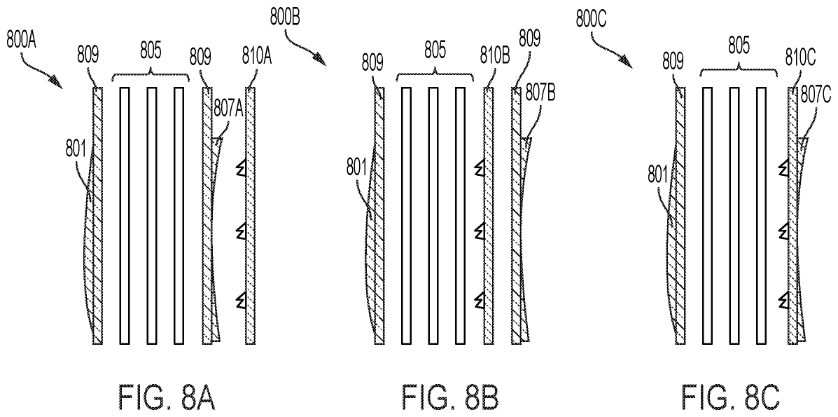

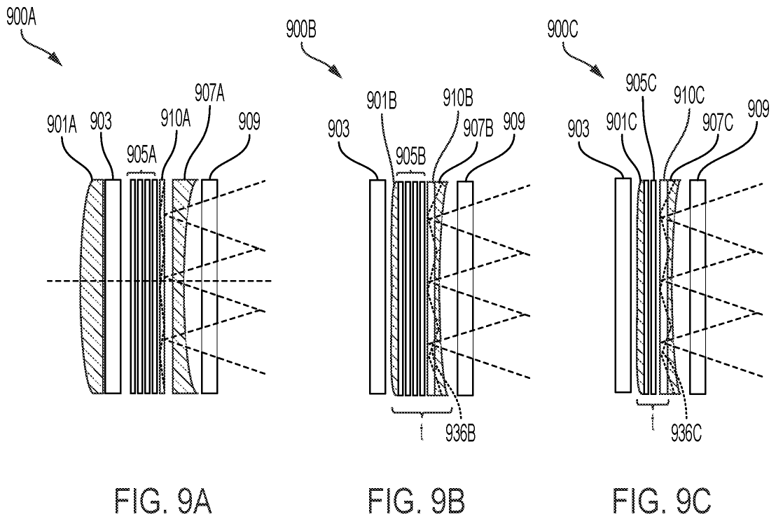

An illumination layer including a thin waveguide, e.g., illumination layers 710A and 710B, can provide design flexibility in the optical system stack. For example, the waveguide illumination layer can be moved to different positions within the stack and/or merged with one or more other optical components. FIGS. 8A-8C and 9A-9C illustrate examples of an optical system stack that include a waveguide illumination layer according to embodiments of this disclosure. The drawings are included for illustrative purposes and may not necessarily be to scale and/or indicate the relative thickness of the layers.

In some embodiments, a waveguide can include in-coupling gratings and out-coupling gratings on both sides or on the same side. The in-coupling gratings may work in a transmission mode. For example, regarding the in-coupling gratings, the light may couple in as it hits the surface relief grating first, then diffract into the substrate, and for out-coupling gratings, the light may hit the grating from within the substrate and the majority of the light may diffract outward towards the user. In some embodiments, the in-coupling gratings may work in a reflection mode. For example, regarding the in-coupling gratings, the light may couple in through the substrate and then hit the surface relief grating on the opposite side which diffracts the light into the substrate, and for out-coupling gratings, the light may hit the grating from within the substrate and diffract more towards the opposite side of the grating, and outward towards the user or another optical element, such as a diffuser. In some embodiments, one of the gratings may work in reflection mode while another grating works in transmission mode. Additionally, in some embodiments, the out-coupling grating elements described herein may include a Fresnel lens function in the pitch of the grating which acts as a diffuser element to spread light (e.g., outward towards the user's eye, such as for improved glint reflection).

FIGS. 8A-8C illustrate optical stacks for an optical system that includes an illumination layer according to embodiments of this disclosure. These figures illustrate the versatility of including a waveguide illumination layer in the optical system. FIG. 8A illustrates an example optical system 800A. For example, the optical system 800A can include an outer lens 801, visible light waveguides 805, a waveguide illumination layer 810A, and an inner lens 807A. The outer lens 801 and inner lens 807A may provide a focused view of the user's environment and/or a digital image. The visible light waveguides 805 can include one or more waveguide layers provided to present digital content to a user. In some examples, the outer lens 801 and/or inner lens 807A can be mounted to a carrier plate 809 for rigidity, e.g., so that the lenses can maintain their shape. As shown in the figure the visible light waveguides 805 can be disposed between outer lens 801 and inner lens 807A, while the illumination layer 810A can be disposed outside inner lens 807A with respect to the visible light waveguides 805.

In one or more examples, the waveguide illumination layer can be disposed between the outer and inner lens. In some examples, the illumination can be disposed between the outer and inner lens, which can provide a better fit for a prescription lens within the optical stack, e.g., prescription lens 509 in optical system 500. For example, FIG. 8B illustrates an example optical system 800B where the waveguide illumination layer 810B is disposed between the outer and inner lens. The optical system 800B can include an outer lens 801, visible light waveguides 805, a waveguide illumination layer 810B, and an inner lens 807B. As shown in the figure, the illumination layer 810B can be disposed between outer lens 801 and inner lens 807B adjacent to the visible light waveguides 805.

FIG. 8C illustrates an example optical system 800C. For example, the optical system 800C can include an outer lens 801, visible light waveguides 805, a waveguide illumination layer 810C, and an inner lens 807. As shown in the figure, the illumination layer 810C can be disposed between outer lens 801 and inner lens 807C with the visible light waveguides 805. In some examples, the inner lens 807C can be coupled to the illumination layer 810C, e.g., instead of being coupled to a carrier plate. For example, in some embodiments, the inner lens 807C can be molded to the illumination layer 810C. In this manner, the illumination layer 810C and inner lens 807C can form a unitary component. This can reduce the overall thickness of the optical system stack 800C compared to optical system stack 800A and 800B.

FIGS. 9A-9C illustrate an eyepiece stack for an illumination layer according to embodiments of this disclosure. These figures illustrate how using the waveguide illumination layer, e.g., illumination layers 710A or 710B, can provide a thin eyepiece stack.

FIG. 9A illustrates an example optical system 900A that can be used in a wearable head device (e.g., wearable head device 202). As shown in the figure, the optical system 900A can include a plurality of optical components arranged in layers. For example, the optical system 900A may include one or more of an outer lens 901A, a dimmer 903, a visible light waveguide 905A, an inner lens 907A, an IR illumination layer 910A, and a corrective prescription insert 909. The optical system 900A may be configured to present a digital image to an eye of a user, present a view of the user's environment, and/or track movement of the user's eye. These components of optical system 900A can perform various functions as discussed above. As shown in the figure, the waveguide illumination layer 910A can be disposed between outer lens 901A and inner lens 907A adjacent to the visible light waveguides 905A. The optical system 900A may be thinner than waveguide optical systems with eye-tracking without a thin waveguide illumination layer. For example, the optical system 500 described above can have a thickness of about 8-12 mm, while the optical system 900A can have a thickness in a range of about 4-8 mm.

FIG. 9B illustrates an example optical system 900B that may be used in a wearable head device (e.g., wearable head device 202). As shown in the figure, the optical system 900B can include a plurality of optical components arranged in layers. For example, the optical system 900B may include one or more of an outer lens 901B, a dimmer 903, a visible light waveguide 905B, an inner lens 907B, an IR illumination layer 910B, and a corrective prescription insert 909. The optical system 900B may be configured to present a digital image to an eye of a user, present a view of the user's environment, and/or track movement of the user's eye. These components of optical system 900B can perform various functions as discussed above. As shown in the figure, in some examples, the waveguide illumination layer 910B can be disposed between outer lens 901B and inner lens 907B with the visible light waveguides 905B. In some examples, the inner lens 907B can be coupled onto the illumination layer 910B, e.g., instead of being coupled to a carrier plate. In some examples, the dimmer 903 can be disposed outside the outer lens 901B, such that the dimmer 903 is not located between the outer lens 901B and inner lens 907B. In some examples, the overall thickness of the optical system 900B can be reduced due to the merging of the inner lens 907B with the waveguide illumination layer 910B. In some examples, the outer lens 901B need not be mounted to carrier plate, which can also reduce the thickness of the optical system 900B. In some examples, the eyepiece stack can have a thickness (t) of about 3.15 mm.

In addition to reducing the bulk and size of the optical system, combining the inner lens 907B to the waveguide illumination layer 910B can provide the waveguide illumination layer 910B with thickness variation due to the curvature of the inner lens 907B. For example, considering the unitary component comprising both the inner lens 907B and the waveguide illumination layer 910B, the curvature of the inner lens 907B may provide a thickness variation of about 50-500 μm. As shown in the figure, in-coupled reflected light 936B reflected via TIR may traverse and be reflected across the combined thickness of the illumination layer 910B and the inner lens 907B. The thickness variation due to the curvature of the inner lens 907B can increase the amount of light incoherence of the in-coupled reflected light 936B. For example, the reflected light 936B may have a greater amount of angle variation, than with a planar illumination layer 910B, e.g., with no thickness variation. The increased light scattering can improve detection of eye glint off a user's eye. Accordingly, the waveguide illumination layer, e.g., 710A or 710B, can contribute to a thinner, lighter optical stack with improved eye tracking capabilities.

FIG. 9C illustrates an example optical system 900C that may be used in a wearable head device (e.g., wearable head device 202). As shown in the figure, the optical system 900B can include a plurality of optical components arranged in layers. For example, the optical system 900C may be similar to FIG. 9C and include one or more of an outer lens 901C, a dimmer 903, a visible light waveguide 905C, an inner lens 907C, an IR illumination layer 910C, and a corrective prescription insert 909. As discussed above with respect to optical system 900B, in some examples, the optical system 900C can include the dimmer disposed outside the outer lens 901C. In some examples, the outer lens 901C may not be mounted to a carrier plate. In some examples, the visible light waveguide 905C can include a single layer, which can further reduce the thickness (t) of the optical stack. In some examples, the inner lens 907C can be coupled, e.g., mounted and/or molded, to the waveguide illumination layer 910C. As discussed above, molding the inner lens inner lens 907C to the illumination layer 910C can improve diffusion of reflected light 936C. In some examples, the thickness (t) of the optical stack of the optical system 900C can be about 2.4 mm. Accordingly, the waveguide illumination layer, e.g., 710A and 710B, can contribute to a thinner, lighter optical stack with improved eye tracking capabilities.

Accordingly, embodiments according to this disclosure can provide a lighter, thinner optical system that can reduce bulk of a head mounted MR/AR system, thereby allowing a user to be more readily immersed in a MR/AR environment. Moreover, embodiments in accordance with this disclosure can reduce haze and visible light loss associated with the illumination layer. Further, in some embodiments, thickness variation of the illumination layer can improve scattering of the IR light used for eye tracking, which can improve eye glint detection as discussed in more detail below.

### Example Illumination Layer Configurations

A waveguide illumination layer according to embodiments of this disclosure can be included in a head wearable device and be used for tracking eye movements of a user. As discussed above, the illumination layer provides light to the eye to cause a glint on the user's eye to be reflected back to the head wearable device. A light sensor can receive the reflected eye glint and the head wearable device can use the reflected eye glint to detect eye movements of the user. In comparison, visible light waveguides can be used in the art for presenting digital content to a user. Accordingly, the structure and layout of a waveguide illumination layer and visible light illumination layers can be different due to the different functions of the waveguide illumination layer and the visible light waveguides.

For example, with a visible light waveguides can be configured to output light across the face of waveguide disposed in front of an eye of the user to provide digital content to the user across a wide field of view (FOV). In this manner a user can look at different areas of the waveguide and have a wide FOV with digital content. Accordingly, the out-coupling grating of a visible light waveguide can be patterned in a continuous area spanning a face of the visible light waveguide, e.g., as in MR system 200 described above. In comparison, a waveguide illumination layer according to embodiments of this disclosure may include one or more out-coupling gratings disposed in multiple discrete areas of the waveguide illumination layer within the FOV of the user.

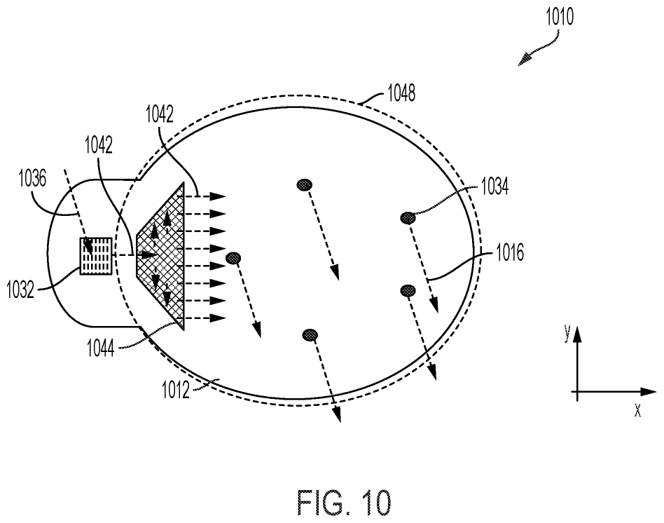

FIG. 10 illustrates an exemplary illumination layer 1010 for a MR system according to embodiments of this disclosure. As shown in the figure, the illumination layer 1010 can include a waveguide 1012, an in-coupling grating 1032, and one or more out-coupling gratings 1034. In some examples, the illumination layer 1010 can include a spreader 1044. The spreader 1044 can be a type of grating provided to spread, e.g., fan out, the internally reflected light 1042. For example, as shown in the figure, the spreader 1044 can propagate internally reflected light 1042 in, at least, the x-direction and the y-direction.

In some examples, the spreader 1044 and the one or more out-coupling gratings can be disposed in region 1048. The region 1048 can correspond to a region of the illumination layer 1010 positioned in front of a user's eye. For example, as shown in the figure, the out-coupling grating 1034 and the spreader 1044 can be disposed in front of a user's eye and/or within the field of view (FOV) of the user. Although the one or more out-coupling gratings and the spreader may be located within the field of view of the user, these components may be invisible to a user, due to, for example, the small size of the one or more out-coupling gratings and/or the index of refraction selected for these components. In some examples, the in-coupling grating 1032 can be located to a side of the FOV of the user. In some examples, the in-coupling grating 1032 can be located near a temple of the user.

In some examples, the in-coupling grating 1032 can be provided to receive and in-couple light 1036 into the waveguide 1012. For example, the in-coupling grating 1032 can be aligned with a LED, e.g., an IR LED, of the optical system of the head wearable device. In some examples, the in-coupled light 1036 can be propagated along a first direction. For example, as shown in the figure, the internally reflected light 1042 leaving the in-coupling grating 1032 can be propagated in the x-direction along the x-axis. In some examples, the grating pattern of the in-coupling grating 1032 can determine the direction the internally reflected light 1042 is propagated. Various grating patterns will be discussed in greater detail below. In some examples, the spreader 1044 can be provided to spread the internally reflected light 1042 from the in-coupling grating 1032 along, at least, the first direction and a second direction. In this manner, the spreader 1044 can spread the internally reflected light 1042 such that the internally reflected light 1042 can reach each of the one or more out-coupling gratings. For example, as shown in the figure, the internally reflected light 1042 can be propagated in at least along the x-axis and along the y-axis within the spreader 1044. The one or more out-coupling gratings 1034 can be disposed at discrete locations of the waveguide 1012.

The one or more out-coupling gratings 1034 can be provided to generate out-coupled light 1016 by coupling internally reflected light 1042 out of the waveguide 1012. For example, as shown in the figure, the out-coupling grating 1034 can receive internally reflected light 1042 that has been spread along a y-direction by spreader 1044. In some examples, each of the out-coupling gratings can have a diameter of about 0.5 mm. While the out-coupling grating is illustrated as a circle, a skilled artisan will understand that a variety of shapes can be used with departing from the scope of this disclosure, e.g., oval, square, rectangle, diamond, semi-circle, etc.

Accordingly, waveguide illumination layers according to embodiments of this disclosure can provide a thin and lightweight waveguide illumination layer. Moreover, the one or more gratings disposed on the waveguide illumination layer may be invisible, e.g., unnoticeable to a user wearing the head wearable device.

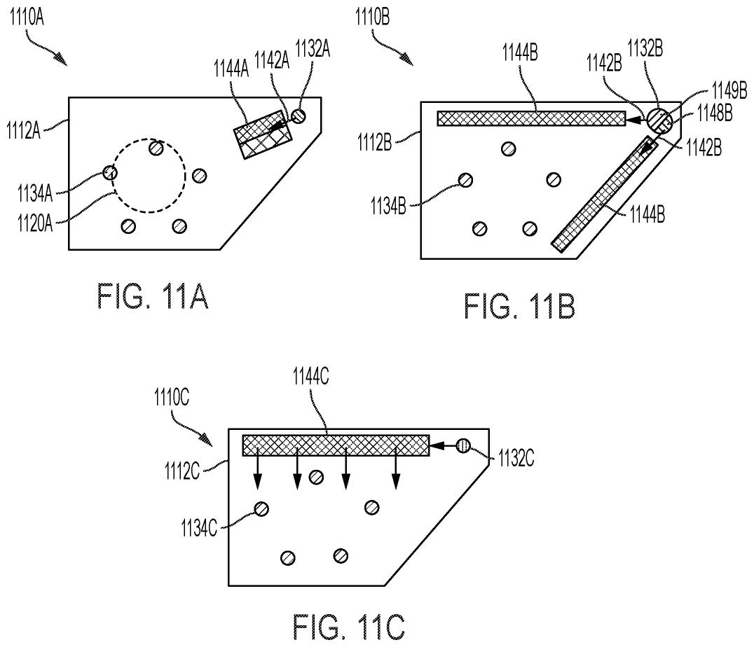

Waveguide illumination layers according to embodiments of this disclosure can include gratings, e.g., in-coupling gratings, out-coupling gratings, and spreaders, in a variety of configurations. FIGS. 11A-11C illustrate exemplary illumination layers 1110A-1110C according to embodiments of this disclosure. These figures can illustrate various exemplary configurations of the in-coupling grating, spreader, and one or more out-coupling gratings. These illustrations are exemplary and a skilled artisan will understand that a number of different configurations, e.g., shape of the waveguide, shape and/or number of in-coupling gratings, spreaders, out-coupling gratings, and relative position of these gratings can be used without departing from the scope of this disclosure.

FIG. 11A illustrates an exemplary illumination layer 1110A for an AR system according to embodiments of this disclosure. As shown in the figure, the illumination layer 1110A can include a waveguide 1112A, an in-coupling grating 1132A, one or more out-coupling gratings 1134A, and a spreader 1144A. The in-coupling grating 1132A, one or more out-coupling gratings 1134A, and a spreader 1144A can be similar to the corresponding components discussed with respect to waveguide illumination layer 1010. In some examples, as shown in the figure, the in-coupling grating 1132A can be located in a position outside the field of view of the user. For example, the location of in-coupling grating 1132A can be near a temple region of the head wearable device, e.g., near a temple of the user.

In some examples, the spreader 1144A can be located between the in-coupling grating 1132A and the out-coupling grating 1134A. As shown in the figure, in some examples, the spreader 1144 can be rectangular in shape. In some examples, the spreader 1144A can include one or more spreader grating patterns disposed adjacent to each other. In one or more examples, the spreader can be provided to facilitate total internal reflection of the internally reflected light. In some examples, the spreader 1144A can have a smaller pitch than the out-coupling grating 1134A and/or the in-coupling grating 1132A for a given wavelength.

As shown in the figure, in some examples, the waveguide illumination layer 1110A can include one or more out-coupling gratings 1134A. In some examples, the waveguide illumination layer can include about five out-coupling gratings 1134A. The number of out-coupling gratings is not intended to limit the scope of this disclosure and more or fewer out-coupling gratings can be used. The out-coupling gratings 1134A can be disposed on a portion of the illumination layer 1110A located in front of an eye 1120A of a user wearing the head mounted device, e.g., within a field of view of the user. A skilled artisan will understand that the location of an eye of various users relative to the out-coupling gratings 1134A and/or waveguide 1112A may not be consistent, and eye 1120 is indicated for illustrative purposes. In some examples, the one or more out-coupling gratings 1134A can be positioned to form an approximate ring around the expected location of the user's eye 1120. In this manner, the one or more out-coupling gratings 1134A can provide light to illuminate a user's eye.

FIG. 11B illustrates an exemplary illumination layer 1110B for an AR system according to embodiments of this disclosure. As shown in the figure, the illumination layer 1110B can include a waveguide 1112, an in-coupling grating 1132B, one or more out-coupling gratings 1134B, and one or more spreaders 1144B. The in-coupling grating 1132B, one or more out-coupling gratings 1134B, and one or more spreaders 1144B can be similar to the corresponding components discussed with respect to waveguide illumination layer 1010. As shown in the figure, the in-coupling grating 1132B can each include two or more grating patterns 1148B, 1149B, such that each of the two or more grating patterns 1148B, 1149B can propagate light in a corresponding direction. For example, a first of the two or more grating patterns 1148B can propagate light 1142B in a first direction while a second of the two or more grating patterns 1149B can propagate light 1142B in a second, different direction.

Accordingly, as shown in the figure, in some embodiments, the illumination layer 1110B can include one or more spreaders 1144B to spread the internally reflected light 1142B from each of the two or more grating patterns 1148B, 1149B. As shown in the figure, in some examples, the one or more spreaders 1144B can be located along one or more edges of the waveguide 1112, e.g., near the perimeter of the waveguide 1112. In this manner, the one or more out-coupling gratings 1134B can receive light from one or more sources, e.g., one or both of the spreaders 1144B. As shown in the figure, in some examples, the spreaders 1144B can be rectangular in shape. The out-coupling gratings 1134B can be configured similar to out-coupling gratings 1134A, discussed above.

FIG. 11C illustrates an exemplary illumination layer 1110C for an AR system according to embodiments of this disclosure. As shown in the figure, the illumination layer 1110C can include a waveguide 1112, an in-coupling grating 1132C, one or more out-coupling gratings 1134C, and a spreader 1144C. The in-coupling grating 1132C, one or more out-coupling gratings 1134C, and spreader 1144C can be similar to the corresponding components described above with respect to FIGS. 11A and 11B. As shown in the figure, for example, the spreader 1144C can be disposed across a top length of the waveguide 1112C near the perimeter. In this manner, the spreader can ensure internally reflected light coupled is expanded across the face of the waveguide 1112C to reach each of the one or more out-coupling gratings 1134C. The out-coupling gratings 1134B can be configured similar to out-coupling gratings 1134A, as discussed above.

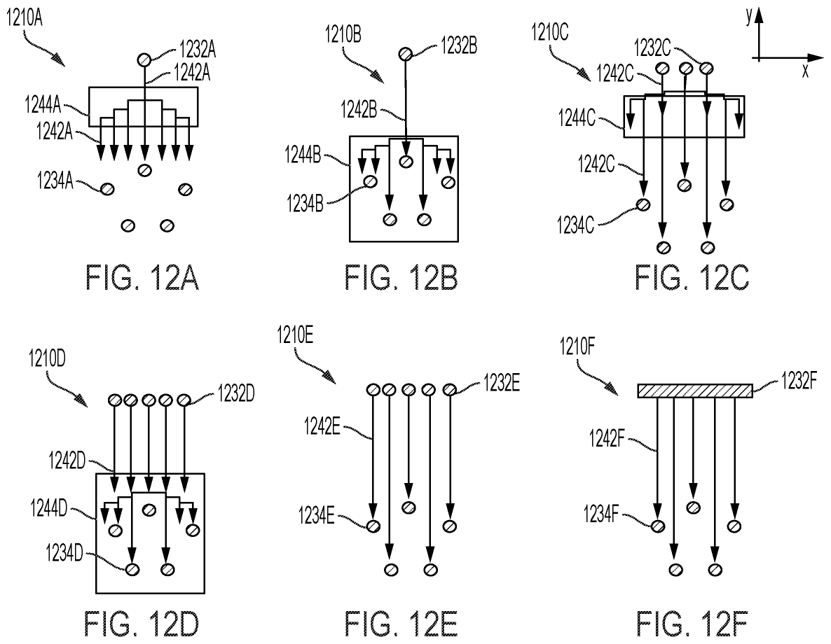

As discussed above, illumination layers according to embodiments of this disclosure can include gratings, e.g., in-coupling gratings, out-coupling gratings, and spreaders, in a variety of configurations. FIGS. 12A-12F illustrate exemplary illumination layers 1210A-1210F, respectively, according to embodiments of this disclosure. These figures can illustrate various exemplary configurations of the in-coupling grating, spreader, and one or more out-coupling gratings. These illustrations are exemplary and a skilled artisan will understand that a number of modifications and/or different configurations, e.g., shape and/or number of in-coupling gratings, spreaders, out-coupling gratings, and relative position of these gratings, can be used without departing from the scope of this disclosure.

FIG. 12A illustrates an exemplary illumination layer 1210A for an AR system according to embodiments of this disclosure. As shown in the figure, the illumination layer 1210A can include an in-coupling grating 1232A and one or more out-coupling gratings 1234A. In some examples, the illumination layer 1210A can include a spreader 1244A, which can be positioned between the in-coupling grating 1232A and the one or more out-coupling gratings 1234A. The in-coupling grating 1232A, one or more out-coupling gratings 1234A, and spreader 1244A can be similar to the corresponding components discussed above. In some examples, the in-coupling grating 1232A can be located in a position outside the field of view of the user. For example, the location of in-coupling grating 1232A can be near a temple region of the head wearable device, e.g., near a temple of the user. In some examples, as shown in the figure, the spreader 1244A can be included near an edge of a FOV of the user and not directly in front of an eye of the user. In some examples, the one or more out-coupling gratings 1234A can be positioned in a region within the FOV of a user, e.g., in front of an eye of a user.

As shown in the figure, in some examples, the in-coupling grating 1232A can be provided to receive and in-couple light into the illumination layer 1210A. In some examples, the in-coupled light can be propagated along a first direction. For example, as shown in the figure, the internally reflected light 1242A leaving the in-coupling grating 1232A can be propagated along the y-axis. In some examples, the spreader 1244A can be provided to spread the internally reflected light 1242A from the in-coupling grating 1232A in at least the first direction and a second direction, e.g., along the x and y axes. In this manner, the spreader 1244A can ensure that the internally reflected light 1242A has a sufficient spread to reach each of the one or more out-coupling gratings. For example, as shown in the figure, without spreader 1244A, the internally reflected light 1242A may not reach each of the one or more out-coupling gratings 1234A. As shown in the figure, the one or more out-coupling gratings 1234A can be disposed at discrete locations of the illumination layer 1210A. The one or more out-coupling gratings 1234A can be provided to out-couple internally reflected light 1242A out of the illumination layer 1210A, toward an eye of the user.

FIG. 12B illustrates an exemplary illumination layer 1210B for an AR system according to embodiments of this disclosure. As shown in the figure, the illumination layer 1210B can include an in-coupling grating 1232B and one or more out-coupling gratings 1234B. In some examples, the illumination layer 1210B can include a spreader 1244B. As shown in the figure, the spreader 1244B can be disposed such that it overlaps with the one or more out-coupling gratings 1234B. The in-coupling grating 1232B, one or more out-coupling gratings 1234B, and a spreader 1244B can be similar to the corresponding components discussed above. In some examples, the in-coupling grating 1232B can be located in a position outside the field of view of the user. For example, the location of in-coupling grating 1232B can be near a temple region of the head wearable device, e.g., near a temple of the user. In some examples, as shown in the figure, the spreader 1244B and the one or more out-coupling gratings 1234B can be positioned in a region within the FOV of a user, e.g., in front of an eye of a user. In such examples, the light being out-coupled by out-coupling grating 1234B may have a higher intensity than, for example, light out-coupled by an out-coupling grating that is not positioned in a region within the FOV of a user. In one or more examples, the one or more out-coupling gratings 1234B can be positioned in a region within the FOV of a user if space for the in-coupling grating is limited, e.g., the in-coupling grating is narrow, and/or there is a single in-coupling grating and input source.

As shown in the figure, in some examples, the in-coupling grating 1232B can be provided to receive and in-couple light into the waveguide illumination layer 1210B. In some examples, the in-coupled light can be propagated along a first direction. For example, as shown in the figure, the internally reflected light 1242B leaving the in-coupling grating 1232B can be propagated in the y-direction. In some examples, the grating pattern of the in-coupling grating 1232B can determine the direction the internally reflected light 1242B is propagated. In some examples, the spreader 1244B can be provided to spread the internally reflected light 1242B from the in-coupling grating 1232B in the first direction and a second direction. For example, as shown in the figure, the spreader 1244B can propagate light along, at least, the x and y axes. In this manner, the spreader 1244B can ensure that the internally reflected light 1242B has a sufficient spread to reach each of the one or more out-coupling gratings 1234B. For example, as shown in the figure, without spreader 1244B, the internally reflected light 1242B may not reach each of the one or more out-coupling gratings 1234A. As shown in the figure, the one or more out-coupling gratings 1034B can be disposed at discrete locations within the spreader 1244B of the illumination layer 1210A. The one or more out-coupling gratings 1234B can be provided to out-couple internally reflected light 1242B out of the illumination layer 1210B, toward an eye of the user.

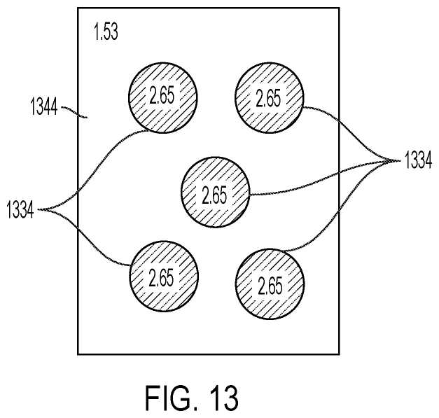

In one or more examples, where the spreader and the one or more out-coupling gratings are located within a FOV of the user, it can be desirable to configure these components to maintain the transparency of the illumination layer within the user's FOV. For example, FIG. 13 illustrates a spreader 1344 having one or more out-coupling gratings disposed therein. The spreader 1344 and one or more out-coupling gratings 1334 can be configured to be positioned in a user's FOV, as discussed above with respect to waveguide illumination layer 1210B. In order to maintain the transparency of the user's FOV, the refractive index of the spreader 1344 can be selected to be relatively transparent, e.g., in a range of about 1.45-2.7. In some examples, the refractive index of the spreader 1344 can be in the range of about 1.52-1.56. In comparison, the one or more out-coupling elements 1634A can be fabricated to have a relatively high index, e.g., in a range of about 1.45-2.7, to ensure that the out-coupling grating 1334 can effectively out-couple the internally reflected light to the eye. In one or more examples, the out-coupling grating 1334 can be coated with a high index material, e.g., silicon carbide, titanium dioxide, zirconium dioxide, etc. or a metal, e.g., aluminum, silver, etc., to improve the diffraction efficiency of the out-coupling grating 1334. The one or more out-coupling gratings may not be noticeable to a user of the AR system, e.g., due to the small diameter, e.g., 0.5 mm, of the out-coupling gratings. In comparison, the spreader may occupy a larger area that may be noticeable to a user. Accordingly, having a difference in refractive indices for the spreader 1344 and the one or more out-coupling gratings 1334 can maintain transparency of the illumination layer without sacrificing the efficiency of the out-coupled light.

FIG. 12C illustrates an exemplary waveguide illumination layer 1210C for an AR system according to embodiments of this disclosure. As shown in the figure, the illumination layer 1210C can include one or more in-coupling gratings 1232C and one or more out-coupling gratings 1234C. In some examples, the illumination layer 1210C can include a spreader 1244C, which can be positioned between the one or more in-coupling gratings 1232C and the one or more out-coupling gratings 1234C. The in-coupling grating 1232C, one or more out-coupling gratings 1234C, and a spreader 1244C can be similar to the corresponding components discussed above. In some examples, the in-coupling grating 1232C can be located in a position outside the field of view of the user. For example, the location of in-coupling grating 1232C can be near a temple region of the head wearable device, e.g., near a temple of the user. In some examples, as shown in the figure, the spreader 1244C can be included near an edge of a FOV of the user and not directly in front of an eye of the user. In some examples, the one or more out-coupling gratings 1234C can be positioned in a region within the FOV of a user, e.g., in front of an eye of a user. In some examples, including more than one in-coupling grating can increase the amount of light received by the out-coupling gratings. In such examples, the out-coupling gratings may be more spread out, e.g., the average distance between out-coupling gratings can be greater, than substrates with a single in-coupling grating.

As shown in the figure, in some examples, the one or more in-coupling gratings 1232C can be provided to receive and in-couple light into the illumination layer 1210C. In some examples, the in-coupled light can be propagated along a first direction. For example, as shown in the figure, the internally reflected light 1242C leaving the one or more in-coupling gratings 1232C can be propagated in the y-direction. In some examples, the spreader 1244C can be provided to spread the internally reflected light 1242C from the in-coupling grating 1232C in at least the first direction and a second direction, e.g., along the x and y axes. In this manner, the spreader 1244C can ensure that the internally reflected light 1242C has a sufficient spread to be received by each of the one or more out-coupling gratings. As shown in the figure, the one or more out-coupling gratings 1234C can be disposed at discrete locations of the illumination layer 1210C. The one or more out-coupling gratings 1234C can be provided to out-couple internally reflected light 1242C out of the illumination layer 1210C, toward an eye of the user.

FIG. 12D illustrates an exemplary illumination layer 1210D for an AR system according to embodiments of this disclosure. As shown in the figure, the illumination layer 1210D can include one or more in-coupling gratings 1232D and one or more out-coupling gratings 1234D. In some examples, the illumination layer 1210B can include a spreader 1244D. As shown in the figure, the spreader 1244D can be disposed such that it overlaps with the one or more out-coupling gratings 1234D. The one or more in-coupling gratings 1232D, one or more out-coupling gratings 1234D, and a spreader 1244D can be similar to the corresponding components discussed above. In some examples, the one or more in-coupling grating 1232D can be located in a position outside the field of view of the user. For example, the location of in-coupling grating 1232D can be near a temple region of the head wearable device, e.g., near a temple of the user. In some examples, as shown in the figure, the spreader 1244D and the one or more out-coupling gratings 1234D can be positioned in a region within the FOV of a user, e.g., in front of an eye of a user. In some examples, including more than one in-coupling grating can increase the amount of light received by the out-coupling gratings.

As shown in the figure, in some examples, the one or more in-coupling gratings 1232D can be provided to receive and in-couple light into the illumination layer 1210D. In some examples, the in-coupled light can be propagated along a first direction. For example, as shown in the figure, the internally reflected light 1242D leaving the in-coupling grating 1232D can be propagated in the y-direction. In some examples, the grating pattern of the in-coupling grating 1232D can determine the direction the internally reflected light 1242D is propagated. In some examples, the spreader 1244D can be provided to spread the internally reflected light 1242D from the in-coupling grating 1232D in at least a first direction and a second direction. For example, as shown in the figure, the spreader 1244D can propagate light along the x and y axes. In this manner, the spreader 1244D can ensure that the internally reflected light 1242D has a sufficient spread to reach each of the one or more out-coupling gratings 1234D. As shown in the figure, the one or more out-coupling gratings 1034D can be disposed at discrete locations within the spreader 1244D of the illumination layer 1010D. The one or more out-coupling gratings 1234D can be provided to out-couple internally reflected light 1242D out of the illumination layer 1210D, toward an eye of the user.

FIG. 12E illustrates an exemplary illumination layer 1210E for an AR system according to embodiments of this disclosure. As shown in the figure, the illumination layer 1210E can include one or more in-coupling gratings 1232E and one or more out-coupling gratings 1234E. As shown in the figure, in some examples, the illumination layer 1210E can omit a spreading element due to the number of in-coupling gratings 1232E. For example, as shown in the figure, each out-coupling grating 1234E can be mapped to a corresponding in-coupling grating 1232E. In some embodiments, the number of in-coupling gratings 1232E may be to ensure that each of the out-coupling gratings 1234E receive internally reflected light 1242E. For example, light in-coupled by the in-coupling gratings 1232E can be propagated along a first direction, e.g., along the y-axis. As shown in the figure, the one or more out-coupling gratings 1234E can be disposed at discrete locations of the illumination layer 1210E and positioned to receive the internally reflected light 1242E from the in-coupling gratings 1232E without a spreader. The one or more out-coupling gratings 1234E can be provided to out-couple internally reflected light 1242E out of the illumination layer 1210E, toward an eye of the user, as discussed above.

FIG. 12F illustrates an exemplary illumination layer 1210F for an AR system according to embodiments of this disclosure. As shown in the figure, the illumination layer 1210F can include an in-coupling grating 1232F and one or more out-coupling gratings 1234F. As shown in the figure, in some examples, the in-coupling grating can have a bar shape that spans a width of the illumination layer 1210F. Accordingly, the illumination layer 1210F can omit a spreader due to the size and configuration of the in-coupling grating 1232F. For example, the dimensions of the in-coupling grating 1232F may be sufficient to ensure that each of the out-coupling gratings 1234F receive internally reflected light 1242F. For example, as shown in the figure, light can be in-coupled along the length of the in-coupling grating 1232F and propagated in the y-direction. As shown in the figure, the one or more out-coupling gratings 1234F can be disposed at discrete locations of the illumination layer 1210F and positioned to receive the internally reflected light 1242F from the in-coupling grating 1232F without a spreader. The one or more out-coupling gratings 1234F can be provided to out-couple internally reflected light 1242F out of the illumination layer 1210F, toward an eye of the user as discussed above.

While the illumination layers 1210A-1210F are shown with specific geometries, and relative sizes of components, these drawings may not be to scale. For example, while the in-coupling gratings and one or more out-coupling gratings are shown as circular in shape, this is not intended to limit the scope of the disclosure and any suitable shape including ovals, rectangles, semi-circles, triangles, polygons, etc. can be used without departing from the scope of this disclosure. Moreover, while in-coupling gratings and one or more out-coupling gratings may be shown as being roughly the same size, in one or more examples, the in-coupling gratings and one or more out-coupling gratings can have a different relative size.

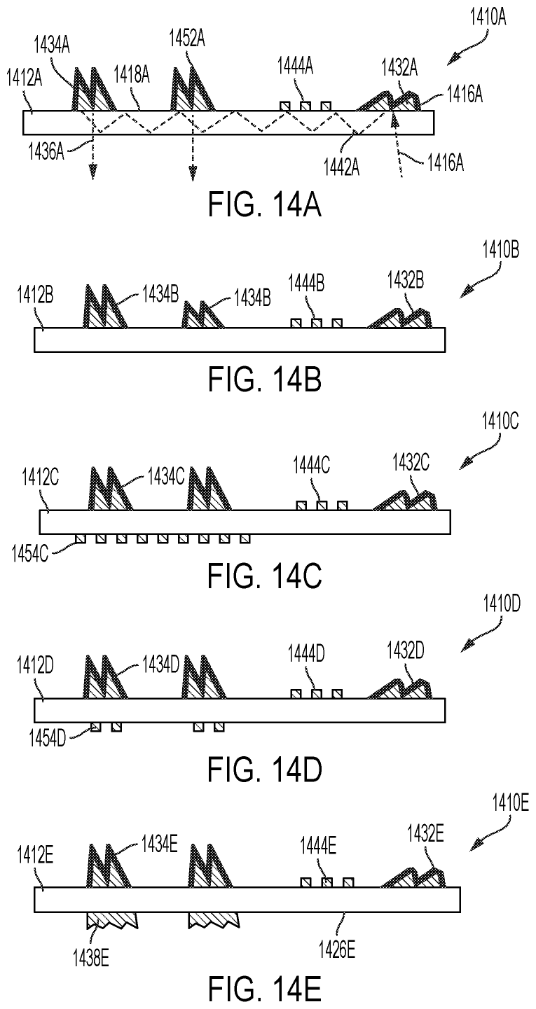

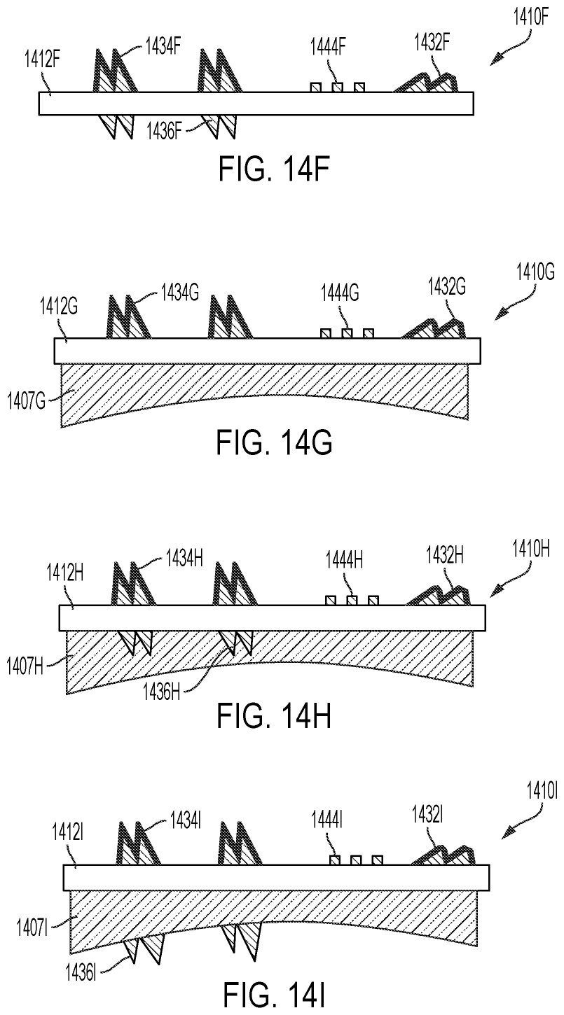

As discussed above, waveguide illumination layers according to embodiments of this disclosure can include gratings, e.g., in-coupling gratings, out-coupling gratings, and spreaders, and other components in a variety of configurations. FIGS. 14A-14I illustrate exemplary illumination layers 1410A-1410F according to embodiments of this disclosure. These figures can illustrate various exemplary configurations of the waveguide components, including in-coupling grating, spreader, one or more out-coupling gratings, diffusers and/or refractive lenses. These illustrations are exemplary and a skilled artisan will understand that a number of different configurations, e.g., shape and/or number of in-coupling gratings, spreaders, out-coupling gratings, and relative position of these gratings can be used without departing from the scope of this disclosure. For example, elements illustrated in the drawings may be not be to scale (unless otherwise indicated) and/or may be emphasized for explanatory purposes.

FIG. 14A illustrates a waveguide illumination layer for an optical system of an AR head wearable device according to embodiments of this disclosure. As shown in the figure, the illumination layer 1410A can include a waveguide 1412A, an in-coupling grating 1432A, one or more out-coupling gratings 1434A, and a spreader 1444A. The in-coupling grating 1432A, one or more out-coupling gratings 1434A, and a spreader 1444A can be similar to the corresponding components discussed above. As shown in the figure, the in-coupling grating 1432A, spreader 1444A, and out-coupling grating 1434A can be disposed on the same face, e.g., a back face 1418A of the waveguide 1412A. In some embodiments, the in-coupling grating 1432A, spreader 1444A, and out-coupling grating 1434A can be disposed on a front face 1442A of the waveguide 1412A. Further, as shown in the figure, the in-coupling grating 1432A may be shorter than the one or more out-coupling gratings 1434A. In such embodiments, the one or out-coupling gratings may have a greater efficiency, e.g., couple a greater amount of light with less losses, compared to in-coupling grating 1432A. In one or more examples, the in-coupling grating 1432A and one or more out-coupling gratings 1434A can be coated with a high index material and/or refractive metal 1452A to improve the efficiency of the gratings. In one or more examples, the in-coupling grating 1434A can diverge light at various angles towards the user's eye, similar to a lens. This coating 1452A is discussed in greater detail below.

FIG. 14B illustrates a waveguide illumination layer for an optical system of an AR head wearable device according to embodiments of this disclosure. As shown in the figure, the illumination layer 1410B can include a waveguide 1412B, an in-coupling grating 1432B, one or more out-coupling gratings 1434B, and a spreader 1444B. The in-coupling grating 1432B, one or more out-coupling gratings 1434B, and a spreader 1444B can be similar to the corresponding components discussed above. Moreover, the configuration of the gratings can be similar to waveguide illumination layer 1410A. However, as shown in the figure, the one or more in-coupling gratings 1434B of waveguide illumination layer 1410B may have different efficiencies. For example, as shown in the figure, a first out-coupling grating 1434B may have first height, while a second out-coupling grating 1434B may have a second height, where the shorter of the two out-coupling gratings 1434B may be less efficient and/or diffractive. In some examples, other features of the one or more out-coupling gratings 1434B may differ to provide the difference in efficiency, e.g., different grating patterns, coatings, etc.

In one or more examples, the efficiencies of the one or more out-coupling gratings 1434B may be configured such that out-coupling gratings closer to the in-coupling grating 1432B are less efficient. For example, due to some light loss and/or scatter as the light is internally reflected in the waveguide 1412B, in-coupled light may have a greater intensity closer to the in-coupling grating 1432B. Referring to illumination layer 1410B, the out-coupling grating on the right, disposed closer to the in-coupling grating 1432B, may receive internally reflected light having a greater intensity than the out-coupling grating 1434B on the left. Accordingly, the efficiencies of the one or more out-coupling gratings 1434B can be tuned to account for this difference in intensity. In one or more examples, additional gratings, e.g., in-coupling gratings and/or spreaders, can be included, e.g., in addition to or instead of tuning the efficiencies of the out-coupling gratings, to ensure that each of the out-coupling gratings 1434B can out-couple light at about the same intensity.

FIG. 14C illustrates a waveguide illumination layer for an optical system of an AR head wearable device according to embodiments of this disclosure. As shown in the figure, the illumination layer 1410C can include a waveguide 1412C, an in-coupling grating 1432C, one or more out-coupling gratings 1434C, and a spreader 1444C. The in-coupling grating 1432C, one or more out-coupling gratings 1434C, and a spreader 1444C can be similar to the corresponding components discussed above. Moreover, the configuration of the gratings can be similar to waveguide illumination layer 1410A. However, as shown in the figure, the waveguide illumination layer 1410C can include an anti-reflective layer 1454C as discussed above with respect to FIGS. 7C and 7D. As shown in the figure, for example, the anti-reflective layer 1454C can be disposed on an opposite face from the one or more out-coupling gratings 1434C. In some examples, the anti-reflective layer 1454C can include at least one selected from an anti-reflective coating and/or an anti-reflective nano-pattern. In some examples, the anti-reflective layer 1454C can be disposed in a region within a user's field of view to improve the transmittance of the waveguide illumination layer 1410C to visible light.

FIG. 14D illustrates a waveguide illumination layer for an optical system of an AR head wearable device according to embodiments of this disclosure. As shown in the figure, the illumination layer 1410D can include a waveguide 1412D, an in-coupling grating 1432D, one or more out-coupling gratings 1434D, and a spreader 1444D. The in-coupling grating 1432D, one or more out-coupling gratings 1434D, and a spreader 1444D can be similar to the corresponding components discussed above. Moreover, the configuration of the gratings can be similar to waveguide illumination layer 1410C. However, as shown in the figure, the anti-reflective layer 1454D can be positioned to overlap the one or more out-coupling gratings 1434D.

FIG. 14E illustrates a waveguide illumination layer for an optical system of an AR head wearable device according to embodiments of this disclosure. As shown in the figure, the illumination layer 1410E can include a waveguide 1412E, an in-coupling grating 1432E, one or more out-coupling gratings 1434E, and a spreader 1444E. The in-coupling grating 1432E, one or more out-coupling gratings 1434E, and a spreader 1444E can be similar to the corresponding components discussed above. Moreover, the configuration of the gratings can be similar to waveguide illumination layer 1410A. However, as shown in the figure, the waveguide illumination layer 1410E can further include one or more diffusers 1438E can be disposed over each of the one or more out coupling gratings 1434E.

In some examples, the one or more diffusers 1438E can be provided on a front surface 1426E of the waveguide 1412E, such that the each of the one or more diffusers 1438E can overlap with each of the one or more out-coupling gratings 1438E. The diffusers can be provided to spread and/or scatter the light out-coupled by the out-coupling gratings 1434E. In some examples, the one or more out-coupling gratings 1434E may out-couple coherent light, such that the out-coupled light is not prone to spreading and/or scattering, e.g., the out-coupled light has a narrow angle or beam. The one or more diffusers 1438E, can receive the coherent light from the out-coupling gratings 1434E and impart spread and/or scattering such that the light received by the eye of a user has a wide angle or beam. In this manner, the eye can receive out-coupled light at multiple angles, which in turn can provide a robust eye glint, e.g., reflected eye light, which can be received by a light sensor of the head wearable device and used for eye tracking.

FIG. 14F illustrates a waveguide illumination layer for an optical system of an AR head wearable device according to embodiments of this disclosure. As shown in the figure, the illumination layer 1410F can include a waveguide 1412F, an in-coupling grating 1432F, one or more out-coupling gratings 1434F, and a spreader 1444F. The in-coupling grating 1432F, one or more out-coupling gratings 1434F, and a spreader 1444F can be similar to the corresponding components discussed above. Moreover, the configuration of the gratings can be similar to waveguide illumination layer 1410A. However, as shown in the figure, the waveguide illumination layer 1410F can include additional set of out-coupling gratings 1436F, such that each of the out-coupling gratings 1434F can have a corresponding out-coupling grating 1436F located opposite the out-coupling gratings 1434F. As shown in the figure, the additional set of out-coupling gratings 1436F may not include a high index and/or reflective metallic coating. In some examples, positioning the additional set of out-coupling gratings 1436F opposite out-coupling gratings 1434F can increase the amount of light out-coupled, e.g., compared to waveguide illumination layer 1410A. In one or more examples, the in-coupling grating 1436F can function as a lens and diverge light at various angles towards the user's eye.

FIG. 14G illustrates a waveguide illumination layer for an optical system of an AR head wearable device according to embodiments of this disclosure. As shown in the figure, the illumination layer 1410G can include a waveguide 1412G, an in-coupling grating 1432G, one or more out-coupling gratings 1434G, and a spreader 1444G. The in-coupling grating 1432G, one or more out-coupling gratings 1434G, and a spreader 1444G can be similar to the corresponding components discussed above. Moreover, the configuration of the gratings can be similar to waveguide illumination layer 1410A. However, as shown in the figure, the waveguide illumination layer 1410G can include a refractive lens coupled to the waveguide 1412G, similar to e.g., waveguide 810C. As discussed above, coupling the waveguide 1412G to a refractive lens 1407G can promote scattering of internally reflected light within the waveguide illumination layer 1410G, which can increase the light scatter of the out-coupled light, thereby improving the detected eye glint.

FIG. 14H illustrates a waveguide illumination layer for an optical system of an AR head wearable device according to embodiments of this disclosure. As shown in the figure, the illumination layer 1410H can include a waveguide 1412H, an in-coupling grating 1432H, one or more out-coupling gratings 1434H, and a spreader 1444H. The in-coupling grating 1432H, one or more out-coupling gratings 1434H, and a spreader 1444H can be similar to the corresponding components discussed above. Moreover, the configuration of the gratings can be similar to waveguide illumination layer 1410G. However, as shown in the figure, the waveguide illumination layer 1410H can include an additional set of out-coupling gratings 1436H, disposed on a front face of the waveguide 1412H, opposite each of the out-coupling gratings 1434H, e.g., such that the additional set of out-coupling gratings 1436H are disposed on top of the waveguide 1412H, but beneath refractive lens 1407H. In some examples, positioning the out-coupling gratings 1436H beneath the lens 1407H can reduce the interaction between outside light and the out-coupling gratings 1436H. As discussed above, coupling the waveguide 1412H to a refractive lens 1407H can promote scattering of internally reflected light within the waveguide illumination layer 1401H, which can increase the light scatter of the out-coupled light, thereby improving the detected eye glint. Further, positioning the additional set of out-coupling gratings 1436H opposite out-coupling gratings 1434H can increase the amount of light out-coupled, e.g., compared to waveguide illumination layer 1410G. Moreover, the additional set of out-coupling gratings 1436H, can receive the coherent light from the out-coupling gratings 1434H and impart spread and/or scattering such that the light received by the eye of a user has a wide angle or beam. In this manner, the eye can receive out-coupled light at multiple angles, which in turn can provide a robust eye glint, e.g., reflected eye light, which can be received by a light sensor of the head wearable device and used for eye tracking.

FIG. 14I illustrates a waveguide illumination layer for an optical system of an AR head wearable device according to embodiments of this disclosure. As shown in the figure, the illumination layer 1410I can include a waveguide 1412I, an in-coupling grating 1432I, one or more out-coupling gratings 1434I, and a spreader 1444I. The in-coupling grating 1432I, one or more out-coupling gratings 1434I, and a spreader 1444I can be similar to the corresponding components discussed above. Moreover, the configuration of the gratings can be similar to waveguide illumination layer 1410G. However, as shown in the figure, the waveguide illumination layer 1410I can include an additional set of out-coupling gratings 1436I, disposed along the curved surface of the refractive lens 1407I, opposite each of the out-coupling gratings 1434I, e.g., such that the additional set of out-coupling gratings 1436I are disposed on top of the refractive lens 1407I. As discussed above, coupling the waveguide 1412I to a refractive lens 1407I can promote scattering of internally reflected light within the waveguide illumination layer 1410I, which can increase the light scatter of the out-coupled light, thereby improving the detected eye glint. Further, positioning the additional set of out-coupling gratings 1436I opposite out-coupling gratings 1434I can increase the amount of light out-coupled, e.g., compared to waveguide illumination layer 1410G. In some examples, positioning the out-coupling gratings 1436I on the exterior of the lens 1407I can allow the internally reflected light to utilize the thickness variation due to the lens curvature and optimize the angular spread of the out-coupled light. Moreover, the additional set of out-coupling gratings 1436H, can receive the coherent light from the out-coupling gratings 1434H and impart spread and/or scattering such that the light received by the eye of a user has a wide angle or beam. In this manner, the eye can receive out-coupled light at multiple angles, which in turn can provide a robust eye glint, e.g., reflected eye light, which can be received by a light sensor of the head wearable device and used for eye tracking.

Accordingly, embodiments of this disclosure provide various configurations of the waveguide illumination layer. For example, unlike visible light waveguides, waveguide illumination layers according to embodiments of this disclosure may include out-coupling gratings in one or more locations to provide one or more beams of incoherent light that can be used to track eye movements of a user. One or more examples according to embodiments of this disclosure can provide a lighter, thinner optical system that can reduce bulk of a head mounted MR/AR system, thereby allowing a user to be more readily immersed in a MR/AR environment.

### Example Grating Configurations

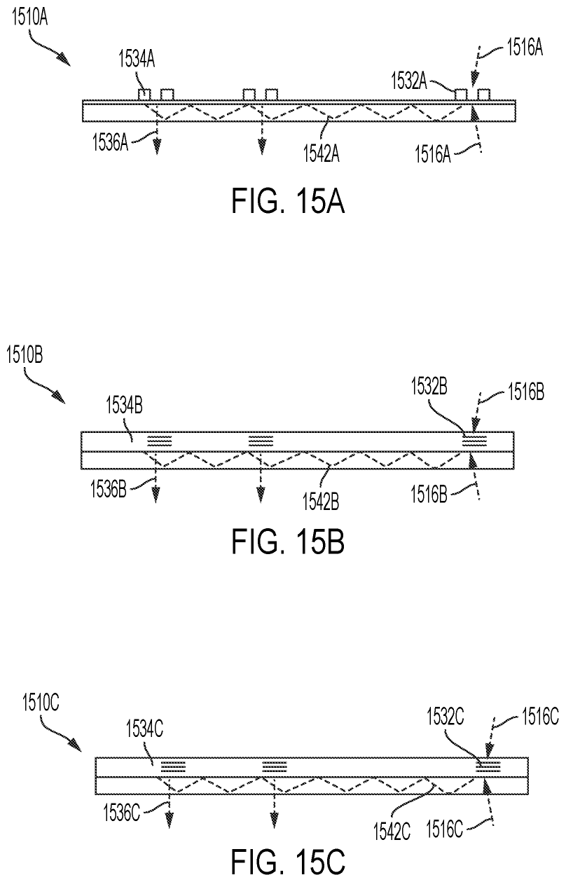

In one or more examples, the gratings, e.g., in-coupling grating, out-coupling gratings, and/or spreader can include one or more of surface relief (SR) gratings, liquid crystal (LC) gratings or volume phase (VP) gratings. FIGS. 15A-15C illustrate exemplary illumination layers for an AR system according to embodiments of the present disclosure. FIG. 15A illustrates an illumination layer 1510A that can use one or more surface-relief (SR) gratings. For example, as shown in the figure the in-coupling grating 1532A and the one or more out-coupling gratings 1534A can include one or more SR gratings. According to embodiments of this disclosure SR gratings can include nano-structures that can form one or more grating patterns, e.g., SR grating patterns. The SR gratings can include one-dimensional nano-structures (e.g., lines, meta-grating lines), two-dimensional nano-structures (e.g., pillars and holes), and/or three-dimensional nano-structures (e.g., multi-cross-sectional). These nano-features can include, for example, binary, slanted, symmetric multi-step, blaze multi-step, blaze sawtooth, etc. In one or more examples, the refractive index of the SR gratings can be in a range of about 1.45-4.0. Various surface relief patterns will be discussed in greater detail below. In one or more examples, the gratings can be coated with a high index material and/or reflective metal (e.g., aluminum, silver, etc.) to increase the grating diffraction efficiency.

FIG. 15B illustrates an illumination layer 1510B that can use one or more LC gratings. For example, as shown in the figure the in-coupling grating 1532B and the one or more out-coupling gratings 1534B can include one or more LC gratings. According to embodiments of this disclosure, external voltages applied at certain frequencies to the LC gratings can change grating direction, thereby allowing light beam steering, e.g., of the in-coupled light, or varying the out-coupling light intensity to optimize eye glint reflection. FIG. 15C illustrates an illumination layer 1510C that can use one or more volume phase (VP) gratings. For example, as shown in the figure the in-coupling grating 1532C and the one or more out-coupling gratings 1534C can include one or more VP gratings. According to embodiments of this disclosure, VP gratings can provide a high efficiency for specific, pre-determined wavelengths and angles of light. For example, VP gratings can be tuned to have greater than 95% efficiency in in-coupling and out-coupling light for a narrow band of an IR source, e.g., for a laser IR source.

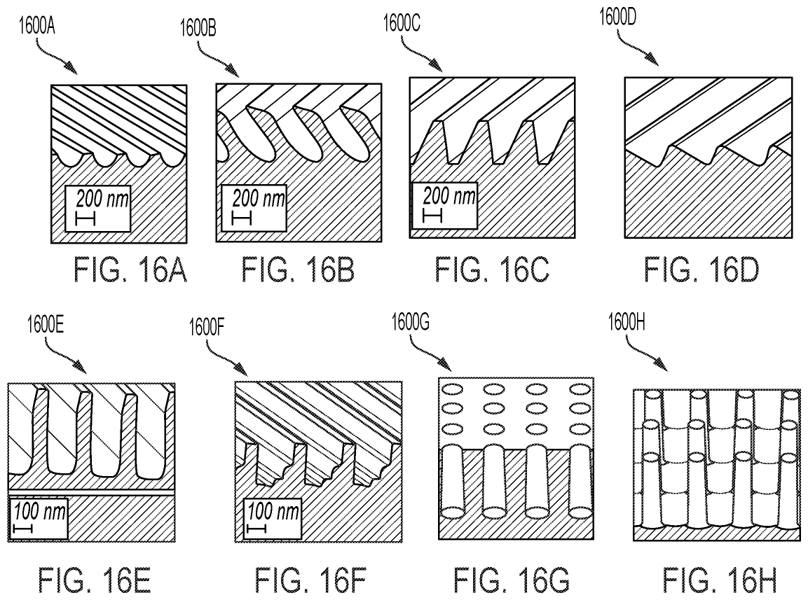

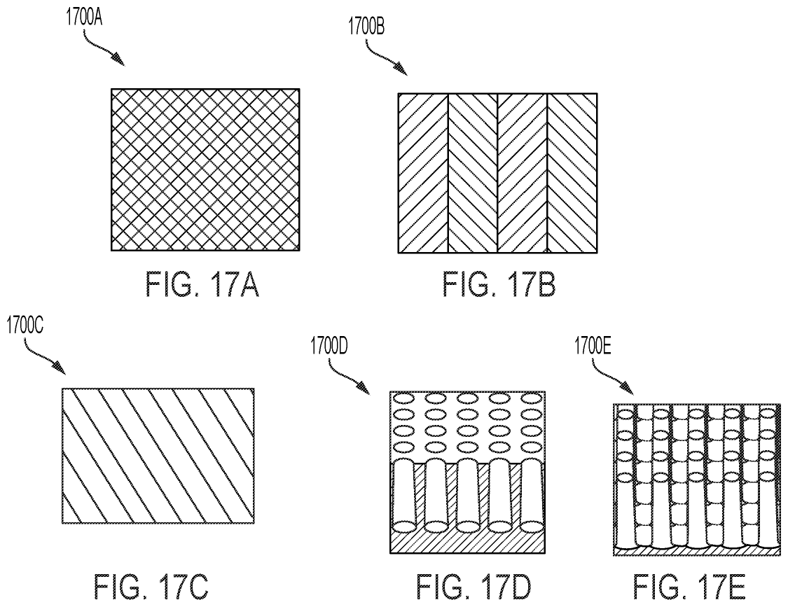

As discussed above, the gratings, e.g., in-coupling grating, out-coupling grating, and spreader, can include one or more grating patterns, e.g., SR grating patterns. In some examples, the grating patterns can include a plurality of nano-structures. The one or more grating patterns used in the gratings can impact how light is reflected by the gratings. In some examples, the grating patterns can be selected based on how light is reflected by the grating patterns. FIGS. 16A-16H illustrate exemplary grating patterns for in-coupling gratings and out-coupling gratings. FIGS. 17A-17E illustrate exemplary grating patterns for spreaders. These grating patterns are exemplary and not intended to limit the scope of this disclosure. Accordingly, other grating patterns can be used according to embodiments of this disclosure.

FIGS. 16A-16H illustrate exemplary grating patterns for in-coupling gratings and out-coupling gratings, e.g., in-coupling grating 1032 and out-coupling grating 1034 as described above. As shown in these figures the in-coupling and/or out-coupling gratings can include a variety of patterns. Each of the patterns may affect how the respective grating receives and reflects light. For example, in some examples the in-coupling grating and out-coupling grating sizes can be selected to minimize light losses due to multiple reflections of light, e.g., when in-coupling light via the in-coupling grating and when out-coupling light via the out-coupling grating. In some examples, the in-coupling grating pitch can based on the substrate index and wavelength of light to be guided. In some examples, equation 1 below can be used to determine the pitch for the in-coupling grating. For example, an IR LED with a peak intensity at 855 nm, can correspond to a pitch of the in-coupling grating in a range of about 698 nm to 570 nm for substrate indices ranging from n=1.45-2.0. In such examples, with these pitch values a fifty percent duty cycle grating pattern can have a line-width range from about 285-349 nm and a height range of about 698-570 nm, e.g., similar to the pitch.

$$Grating Pitch = \frac{2 \cdot λ}{( 1 + n )} \qquad ( 1 )$$

FIG. 16A illustrates an example binary lines and spaces structure 1600A according to one or more embodiments of this disclosure. In some examples, the light reflected by structure 1600A may be non-directional. For example, the light reflected by the structure 1600A can be directed toward an environment of a user wearing a head wearable device and/or internally reflected into a substrate. FIG. 16B illustrates an exemplary slanted (or blazed) lines and spaces structure 1600B according to one or more embodiments of this disclosure. In some examples, the angle and direction of the slant may be tuned to direct light in a desired direction. FIG. 16C illustrates an exemplary line and space structure with a triangular cross-section 1600C according to one or more embodiments of this disclosure. FIG. 16D illustrates an exemplary saw-tooth structure 1600D according to one or more embodiments of this disclosure. In some examples, the angle and direction of the saw-tooth may be tuned to direct light in a desired direction.

FIG. 16E illustrates an exemplary binary structure 1600E according to one or more embodiments of this disclosure. In some examples, the light reflected by structure 1600E may be non-directional. As shown in this figure, binary structure 1600E can have a height greater than a pitch of the pattern. FIG. 16F illustrates an exemplary multi-step saw-tooth structure 1600F according to one or more embodiments of this disclosure. In some examples, the angle and direction of the saw-tooth may be tuned to direct light in a desired direction. FIG. 16G illustrates an exemplary holes-and-spaces structure 1600G according to one or more embodiments of this disclosure. In some examples, the light reflected by structure 1600G may be non-directional. While the holes shown in holes-and-spaces structure 1600G can have a circular cross-section, e.g., when viewed from a top surface, the holes can have any suitable shape including, but not limited to, circular, oval, rounded rectangle, diamond, etc. FIG. 16G illustrates an exemplary pillars structure 1600H according to one or more embodiments of this disclosure. While the pillars structure 1600H can have a circular cross-section, e.g., when viewed from a top surface, the pillars can have any suitable shape including, but not limited to, circular, oval, rounded rectangle, diamond, etc. In some examples, the light reflected by structure 1600H may be non-directional. In some examples, the pillars can be slanted at an angle in a range of 45-90 degrees. While the structures 1600A-1600H are shown with a particular pitch and width, these specific examples are not intended to limit the scope of this disclosure. Moreover, structures 1600A-1600H are exemplary and other nano-structure patterns can be used without departing from the scope of this disclosure.

FIGS. 17A-17E illustrate exemplary nano-structure patterns for a spreader according to one or more embodiments of this disclosure. As discussed above, the spreader can be provided to fan out, e.g., spread light internally reflected light from the in-coupling grating. In one or more examples, the spreader 1044 can include one or more SR grating patterns. In some embodiments, the spreader can be patterned on either or both sides of the waveguide, e.g., as in waveguides 1412A-1412I. In some examples, the spreader can have a smaller pitch than the out-coupling grating to increase the directional spread of the diffracted order of light in total internal reflection without out-coupling the light over the face of the waveguide. In some examples, the pitch can be about 250-500 nm.

FIG. 17A illustrates an exemplary meta-grating structure 1700A for a spreader according to embodiments of this disclosure. The meta-grating structure 1700A can be configured to spread light in one or more directions as discussed above. In some examples, the meta-grating structure can include either pillars or holes in a hexagonally packed configuration, where the pillars and/or holes are located at the intersection points of the lines. FIG. 17B illustrates an exemplary lines and spaces structure 1700B for a spreader according to embodiments of this disclosure. As shown in the figure, the lines of structure 1700B can be oriented in one or more directions. The lines and spaces structure 1700B can be configured to spread light in one or more directions as discussed above. FIG. 17C illustrates an exemplary lines and spaces structure 1700C for a spreader according to embodiments of this disclosure. The lines and spaces structure 1700C can be configured to spread light in one or more directions as discussed above. FIG. 17D illustrates an exemplary holes structure 1700D for a spreader according to embodiments of this disclosure. The holes structure 1700D can be configured to spread light in one or more directions as discussed above. FIG. 17E illustrates an exemplary pillars structure 1700E for a spreader according to embodiments of this disclosure. The pillars structure 1700E can be configured to spread light in one or more directions as discussed above. For example, the light can be configured to be diffracted along its original path and/or be internally reflected within the substrate.

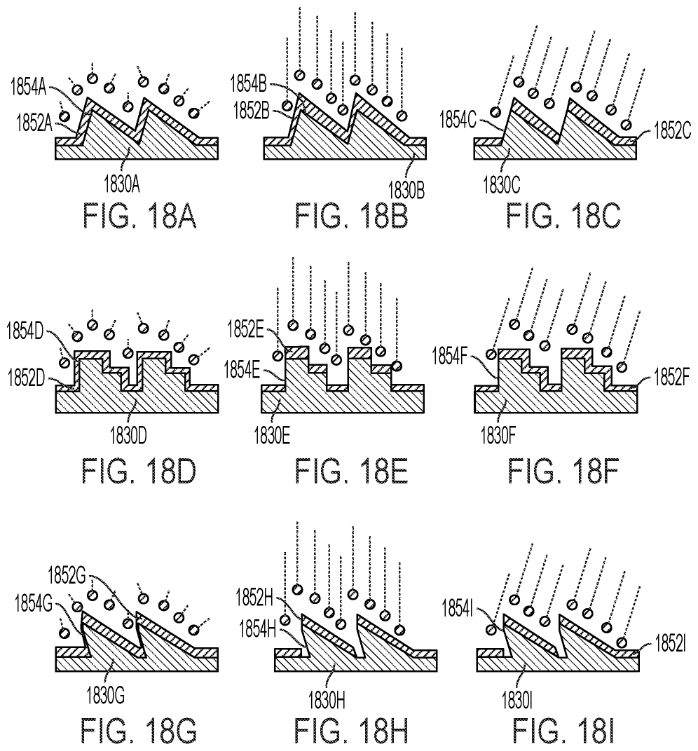

As discussed above, in one or more examples the one or more out-coupling gratings can be coated with a high index (e.g., titanium oxide, zirconium oxide, silicon carbide) material and/or a reflective metal (e.g., aluminum, silver, etc.). For example, FIGS. 18A-18H illustrate one or more gratings 1830A-1830H of an illumination layer according to embodiments of this disclosure. Moreover, these figures illustrate different deposition processes for coating one or more gratings of having different nano-structure geometries. As shown in these figures, varying the shape of the grating as well as the deposition process can impact how the coating is deposited across the surface of the nano-structures, which in turn can impact the diffractional efficiency of the nano-structures for different angles of light.

For example, FIGS. 18A-18C illustrate one or more exemplary saw-tooth gratings 1830A-1830C according to embodiments of this disclosure. FIG. 18A, illustrates a saw-tooth grating 1830A having a coating 1852A disposed thereon. The coating 1852A can be, for example, a high index material and/or a reflective metal. The coating 1852A can be deposited using a conformal method, e.g., a sputtering process and/or low pressure vapor deposition process. As shown in this figure, the conformal deposition method can provide a coating 1852A having an approximately uniform thickness. FIG. 18B illustrates a saw-tooth grating 1830B having a coating 1852B disposed thereon. The coating 1852B can be, for example, a high index material and/or a reflective metal. The coating 1852B can be deposited using an evaporation deposition process that deposits the coating in a straight, e.g., overhead manner. As shown in the figure, the evaporation deposition process may provide a coating 1852B on surfaces that have a horizontal component, e.g., surfaces that are not vertical faces, and/or the coating may be thinner on surfaces that are slanted at a steep angle. FIG. 18C illustrates a saw-tooth grating 1830C having a coating 1852C disposed thereon. The coating 1852C can be, for example, a high index material and/or a reflective metal. The coating 1852C can be deposited using an angled evaporation deposition process that deposits the coating at an angle. As shown in the figure, the evaporation deposition process may provide a coating 1852C on surfaces that are exposed to the angle of deposition. As shown in the figure, the back surface 1854A of the saw-tooth grating need not have coating 1852C disposed thereon.

FIGS. 18D-18F illustrate one or more exemplary multi-step gratings 1830D-1830F according to embodiments of this disclosure. FIG. 18D, illustrates a multi-step grating 1830D having a coating 1852D disposed thereon. The coating 1852D can be, for example, a high index material and/or a reflective metal. The coating 1852D can be deposited using a conformal method, e.g., a sputtering process and/or low pressure vapor deposition process. As shown in this figure, the conformal deposition method can provide a coating 1852D having an approximately uniform thickness. FIG. 18E illustrates a saw-tooth grating 1830E having a coating 1852E disposed thereon. The coating 1852E can be, for example, a high index material and/or a reflective metal. The coating 1852E can be deposited using an evaporation deposition process that deposits the coating in a straight, e.g., overhead manner. As shown in the figure, the evaporation deposition process may provide a coating 1852E on surfaces that have a horizontal component, e.g., surfaces that are not vertical faces. For example, vertical surface 1854E need not have the coating 1852E disposed thereon. FIG. 18F illustrates a multi-step grating 1830F having a coating 1852F disposed thereon. The coating 1852F can be, for example, a high index material and/or a reflective metal. The coating 1852F can be deposited using an angled evaporation deposition process that deposits the coating at an angle. As shown in the figure, the evaporation deposition process may provide a coating 1852F on surfaces that are exposed to the angle of deposition. As shown in the figure, the vertical surface 1854F need not have coating 1852F disposed thereon.

FIGS. 18G-18I illustrate one or more exemplary shark-fin gratings 1830G-1830I according to embodiments of this disclosure. FIG. 18G, illustrates a shark-fin grating 1830G having a coating 1852G disposed thereon. The coating 1852G can be, for example, a high index material and/or a reflective metal. The coating 1852G can be deposited using a conformal method, e.g., a sputtering process and/or low pressure vapor deposition process. Unlike the conformal coatings for the saw-tooth grating 1830A and the multi-step grating 1830D, the coating 1852G need not have a uniform thickness across the surface of the grating 1830G. For example, the coating 1852G need not deposit onto surface 1854G due to its angle. For example, the angle of the surface 1854G relative to the waveguide substrate may make it difficult for particles deposited via the sputtering and/or low vapor deposition to be deposited thereon. FIG. 18H illustrates a shark-fin grating 1830H having a coating 1852H disposed thereon. The coating 1852H can be, for example, a high index material and/or a reflective metal. The coating 1852H can be deposited using an evaporation deposition process that deposits the coating in a straight, e.g., overhead manner. Similar to surface 1854G, coating 1852H need not be deposited onto surface 1854H due to its angle. FIG. 18I illustrates a shark-fin grating 1830I having a coating 1852I disposed thereon. The coating 1852I can be, for example, a high index material and/or a reflective metal. The coating 1852I can be deposited using an angled evaporation deposition process that deposits the coating at an angle. As shown in the figure, the evaporation deposition process may provide a coating 1852I on surfaces that are exposed to the angle of deposition. As shown in the figure, the vertical surface 1854I need not have coating 1852I disposed thereon.

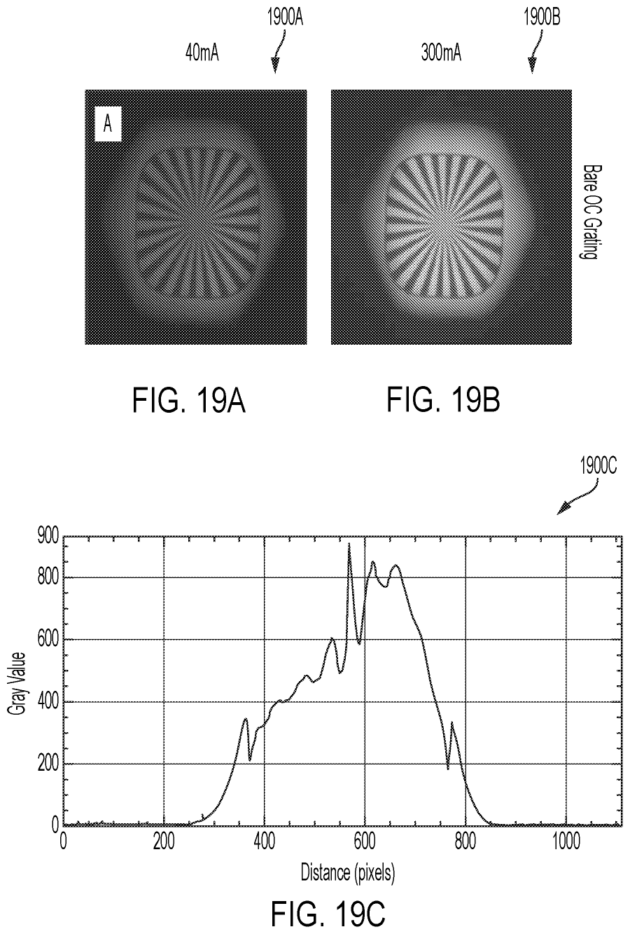

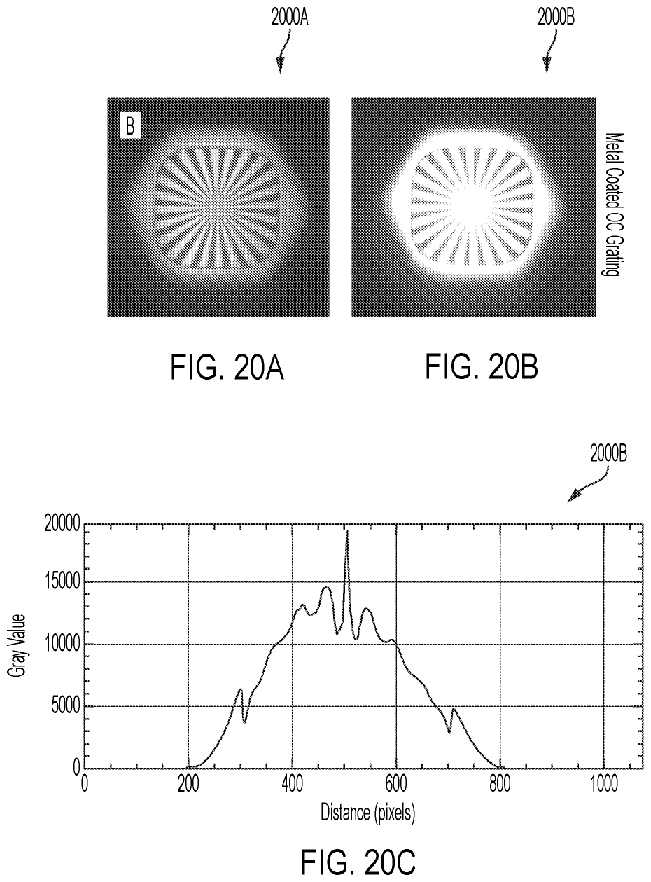

FIGS. 19A-19C and 20A-20C illustrate the difference in efficiency between a bare grating and a grating coated with a high index material and/or a reflective metal. FIGS. 19A-19C correspond to a bare grating, while FIGS. 20A-20C correspond to a grating coated with a high index material and/or a reflective metal. For example, FIG. 19A illustrates an exemplary light intensity 1900A that can be out-coupled from a 1 mm diameter polygonal out-coupling element with a blazed structure having an index of 1.65, and an input LED input amperage of 40 mA. FIG. 19B illustrates an exemplary light intensity 1900B that can be out-coupled from a 1 mm diameter polygonal out-coupling element with a blazed structure having an index of 1.65, and an input LED input amperage of 300 mA. FIG. 19C illustrates a graph 1900C that corresponds to the brightness of the out-coupled light of the exemplary light intensity 1900B. As shown in FIG. 19C, the maximum intensity for the uncoated grating can be about 900 units.

FIG. 20A illustrates an exemplary light intensity 2000A that can be out-coupled from a 1 mm diameter polygonal out-coupling element with a blazed structure having an index of 1.65, coated conformally with aluminum and an input LED amperage of 40 mA. FIG. 20B illustrates an exemplary light intensity 2000B that can be out-coupled from a 1 mm diameter polygonal out-coupling element with a blazed structure having an index of 1.65, coated conformally and an input LED amperage of 300 mA. In comparison to light intensities 1900A and 1900B, light intensities 2000A and 2000B are clearly brighter, e.g., more efficient at out-coupling light at the for the same amperage. Indeed, light intensity 2000A (corresponding to an input amperage of 40 mA) appears brighter than light intensity 1900B (corresponding to an input amperage of 300 mA). FIG. 20C illustrates a graph 2000C that corresponds to the brightness of the out-coupled light of the exemplary light intensity 2000B. As shown in FIG. 20C, the maximum intensity for the uncoated grating can be about 20,000 units. In comparison to the maximum intensity shown in graph 1900C, the coated gratings of graph 2000C provide an improvement of light throughput of about 2000%.

### Fabrication Process

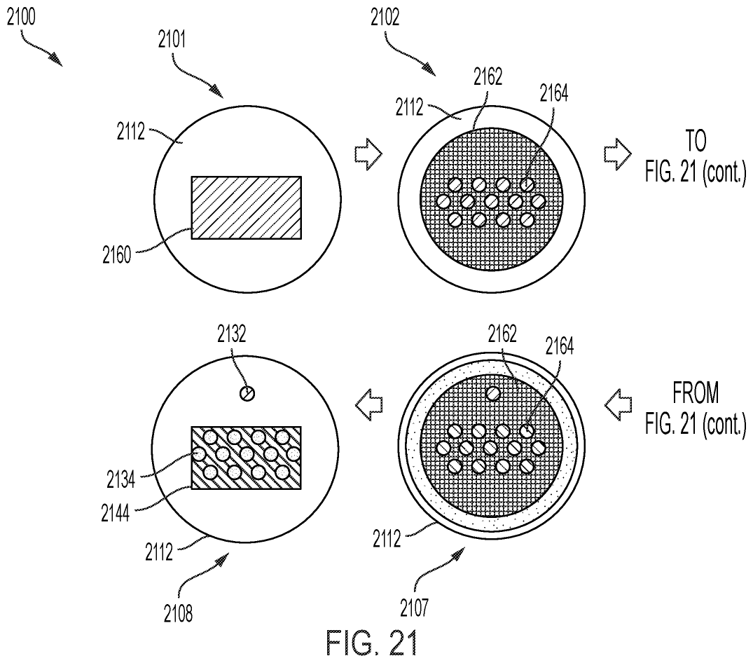

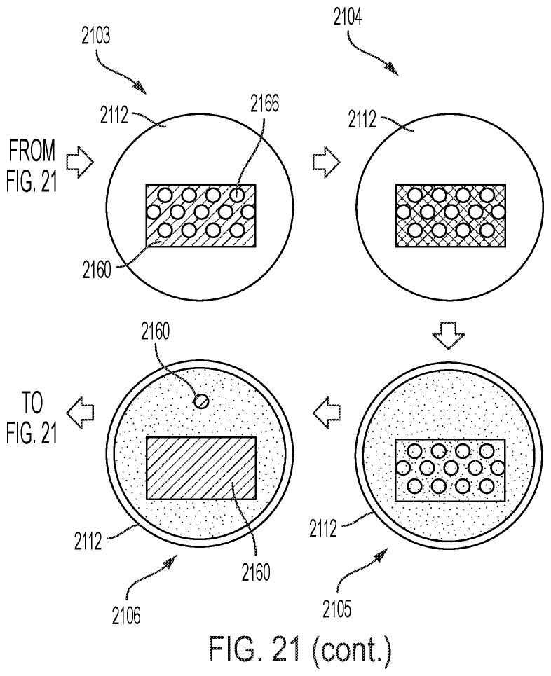

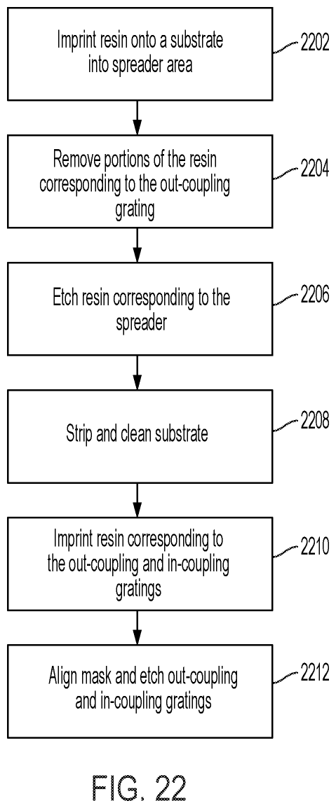

FIG. 21 illustrates an exemplary process 2100 for fabricating a waveguide illumination layer according to embodiments of this disclosure. For example, FIG. 21 illustrates a waveguide illumination layer at various stages during the fabrication process. FIG. 22 illustrates an example block diagram directed to process 2200 for fabricating a waveguide illumination layer according to embodiments of this disclosure. For example, process 2200 can be directed to the steps for fabricating a waveguide illumination layer. Processes 2100 and 2200 may be referred to together to describe the fabrication process. Processes 2100 and 2200 are exemplary and other processes can be used to fabricate the waveguide illumination layer without departing from the scope of this disclosure.

In one or more embodiments, as shown in 2101, a substrate 2112 can be imprinted with material 2160 in an area where a spreader 2144 will be located (step 2202). In some examples, the material can be a resin, e.g., a UV sensitive resin. In one or more embodiments, as shown in 2102, a metal mask 2162 can be overlaid on the substrate 2112. The metal mask 2162 can include one or more apertures 2164 corresponding to a desired location of the out-coupling gratings. The resin located beneath the apertures can be removed (step 2204). For example, UV light can be applied to the substrate 2112 to remove the UV sensitive resin. The resulting structure is shown in 2103, where the substrate 2112 includes the imprint material 2160 with one or more holes 2166 corresponding to the desired location of the out-coupling gratings.

In one or more embodiments, as shown in 2104, the imprint material 2160 can be etched (step 2206) to form the nano-structures, e.g., SR gratings, for the spreader 2144. In one or more embodiments, as shown in 2105, the substrate can be stripped, and cleaned (step 2208). In one or more embodiments, as shown in 2106, the substrate 2112 can be imprinted with imprint material 2160 in the regions of the substrate corresponding to the in-coupling grating and the out-coupling grating (step 2210). The imprint material can be, for example, UV sensitive resin. In one or more embodiments, as shown in 2107, the metal mask 2162 can be overlaid on the substrate 2112. The metal mask 2162 can include one or more apertures 2164 corresponding to a desired location of the in-coupling gratings and the out-coupling gratings. The resin located beneath the apertures can be etched (step 2212). The in-coupling gratings and the out-coupling gratings can be etched according to the one or more patterns discussed above. Thus, as shown in 2108, an illumination layer 2112 having an in-coupling grating 2132, out-coupling grating 2134, and spreader 2144 can be fabricated.

A skilled artisan will understand that processes 2100 and 2200 are exemplary and other processes can be used to fabricate the waveguide illumination layer without departing from the scope of this disclosure. For example, in some embodiments, a master template can be used to fabricate the waveguide illumination layer, where the master template includes the SR grating patterns for the in-coupling grating, out-coupling grating, and the spreader. For example, such processes can include jet and flash imprint lithography processes. In some examples, a soft mold can be used to fabricate one or more portions of the illumination waveguide as described in Nanoimprint Lithography Methods on Curved Substrates, which is hereby incorporated into this disclosure in its entirety.

Disclosed herein are systems and methods for displays, such as for a head wearable device. Embodiments in accordance with this disclosure can provide a display that can include an infrared illumination layer, the infrared illumination layer including a waveguide having a first face and a second face, the first face disposed opposite the second face. In some examples, the illumination layer may also include an in-coupling grating disposed on the first face, the in-coupling grating configured to couple light into the waveguide to generate internally reflected light propagating in a first direction. In some examples, the illumination layer may also include a plurality of out-coupling gratings disposed on at least one of the first face and the second face, the plurality of out-coupling gratings can be configured to receive the internally reflected light and couple the internally reflected light out of the waveguide.

In one or more examples, the display can include a spreader disposed on at least one of the first face and the second face of the waveguide, the spreader can be configured to propagate the internally coupled light in the first direction and further in a second, different direction. In one or more examples, the spreader can include at least one nano-pattern selected from lines, meta-grating, holes, and pillars. In one or more examples, a pitch of the spreader can be in a range of approximately 250-500 nm.

In one or more examples, the display can include a plurality of diffusers, wherein each diffuser can be disposed on a waveguide face opposite each of the plurality of out-coupling gratings. In one or more examples, a width of each of the plurality of out-coupling gratings and a width of the in-coupling grating can be approximately the same. In one or more examples, a diameter of the out-coupling grating of the display can be approximately 0.5 mm. In one or more examples, the plurality of out-coupling gratings can include at least one nano-pattern selected from lines, meta-grating, holes, pillars, saw-tooth, blazed, and multi-tier. In one or more examples, the in-coupling grating can include at least one nano-pattern selected from lines, meta-grating, holes, pillars, saw-tooth, blazed, and multi-tier. In one or more examples, the display can include a high index coating disposed on at least one of a surface of the in-coupling grating and a surface of an out-coupling grating of the plurality of out-coupling gratings. In one or more examples, the display can include a lens coupled to the second face of the waveguide, wherein the lens can include a curved surface. In one or more examples, two or more of the plurality of out-coupling gratings can be disposed on the curved surface of the lens. In one or more examples, the curved surface of the lens can have a thickness variation of about 50-100 μm.

In one or more examples, the display can include a first out-coupling grating of the plurality of out-coupling gratings that can be disposed a first distance away from the in-coupling grating. In some examples, the display can further include a second out-coupling grating of the plurality of out-coupling gratings that can be disposed a first distance away from the in-coupling grating, wherein the second distance is greater than the first distance. In some examples, the first out-coupling grating can exhibit a first diffraction efficiency and the second out-coupling grating exhibits a second diffraction efficiency greater than the first efficiency.

Embodiments in accordance with this disclosure can provide a display that can include an illumination layer including a waveguide having a first face and a second face, the first face disposed opposite the second face. In some examples, the illumination layer can include an in-coupling grating disposed on the first face, the in-coupling grating configured to couple light into the waveguide to generate internally reflected light propagating in a first direction. In some examples, the illumination layer can include a plurality of out-coupling gratings disposed on at least one of the first face and the second face, where the plurality of out-coupling gratings can be configured to receive the internally reflected light and couple the internally reflected light out of the waveguide to generate out-coupled light.

In one or more examples, the display can include a visible light waveguide, the visible light waveguide can be configured to present digital content. In one or more examples, the display can include a light sensor, where the light sensor can be configured to detect at least a portion of the out-coupled light that is reflected off an eye of a user. In one or more examples, the display can include a spreader that can be disposed on at least one of the first face and the second face of the waveguide, where the spreader can be configured to propagate the internally coupled light in the first direction and further in a second, different direction. In one or more examples, the display can include a plurality of diffusers, where each diffuser of the plurality of diffusers can be disposed on a waveguide face opposite an out-coupling grating of the plurality of out-coupling gratings. In one or more examples, the display can include a lens coupled to the second face of the waveguide, where the lens can include a curved surface.

Embodiments in accordance with this disclosure can provide a method including imprinting a first resin onto a first surface of a substrate, where the resin can be deposited into a first region. In some examples, the method can include removing a first portion of the first resin within the first region to form a second region. In some examples, the method can include etching the first resin in the first region with a first nano-pattern. In some examples, the method can include striping and cleaning the substrate. In some examples, the method can include imprinting a second resin onto the first surface of the substrate, where the second resin is deposited into the second region. In some examples, the method can include etching the second resin in the second region with a second nano-pattern.

In one or more examples, the method can include imprinting the second resin onto the first surface of the substrate, where the second resin is deposited into a third region and wherein the third region is not contiguous with the first region. In one or more examples, the method can include imprinting a third resin onto a second surface of the substrate, wherein the third resin is deposited onto a fourth region of the substrate, and wherein the second surface of the substrate is opposite the first surface and the fourth region is opposite the second region.

Although the disclosed examples have been fully described with reference to the accompanying drawings, it is to be noted that various changes and modifications will become apparent to those skilled in the art. For example, elements and/or components illustrated in the drawings may be not be to scale and/or may be emphasized for explanatory purposes. As another example, elements of one or more implementations may be combined, deleted, modified, or supplemented to form further implementations. Other combinations and modifications are to be understood as being included within the scope of the disclosed examples as defined by the appended claims.

1. A display comprising:
a waveguide having a first face and a second face, the first face disposed opposite the second face with respect to the waveguide;
an in-coupling grating disposed on the first face, the in-coupling grating configured to couple light into the waveguide to propagate internally reflected light in a first direction; and
a plurality of out-coupling gratings disposed on at least one of the first face and the second face, the plurality of out-coupling gratings configured to receive the internally reflected light and to couple the internally reflected light out of the waveguide.

2. The display of claim 1, further comprising a spreader disposed on at least one of the first face and the second face of the waveguide, the spreader configured to propagate the internally reflected light in the first direction and to further propagate the internally reflected light in a second, different direction.

3. The display of claim 2, wherein the spreader comprises at least one nano-pattern selected from lines, meta-grating, holes, and pillars.

4. The display of claim 1, further comprising a plurality of diffusers, wherein each diffuser of the plurality of diffusers is disposed opposite an out-coupling grating of the plurality of out-coupling gratings with respect to the waveguide.

5. The display of claim 1, wherein a width of each out-coupling grating of the plurality of out-coupling gratings is approximately equal to a width of the in-coupling grating.

6. The display of claim 1, wherein the plurality of out-coupling gratings comprises at least one nano-pattern selected from lines, meta-grating, holes, pillars, saw-tooth, slanted, and multi-tier.

7. The display of claim 1, wherein the in-coupling grating comprises at least one nano-pattern selected from lines, meta-grating, holes, pillars, saw-tooth, slanted, and multi-tier.

8. The display of claim 1, further comprising a high index coating disposed on at least one of a surface of the in-coupling grating and a surface of an out-coupling grating of the plurality of out-coupling gratings.

9. The display of claim 1, wherein the waveguide corresponds to an illumination layer.

10. The display of claim 9, wherein the infrared illumination layer has a variable thickness.

11. The display of claim 9, wherein the illumination layer comprises a lens coupled to the second face of the waveguide, wherein the lens includes a curved surface.

12. The display of claim 11, wherein two or more out-coupling gratings of the plurality of out-coupling gratings are disposed on the curved surface of the lens.

13. The display of claim 1, wherein:
a first out-coupling grating of the plurality of out-coupling gratings is disposed a first distance away from the in-coupling grating,
a second out-coupling grating of the plurality of out-coupling gratings is disposed a second distance away from the in-coupling grating, wherein the second distance is greater than the first distance, and
the first out-coupling grating exhibits a first diffraction efficiency and the second out-coupling grating exhibits a second diffraction efficiency greater than the first efficiency.

14. The display of claim 1, further comprising a visible light waveguide, the visible light waveguide configured to present digital content.

15. The display of claim 1, wherein the internally reflected light coupled out of the waveguide comprises out-coupled light.

16. The display of claim 15, further comprising a light sensor, the light sensor configured to detect at least a portion of the out-coupled light that is reflected off an eye of a user.

17. The display of claim 1, wherein the plurality of out-coupling gratings comprises at least one of a surface relief grating, a liquid crystal grating, and a volume phase grating.

18. A method comprising:
imprinting a first resin onto a first surface of a substrate, wherein imprinting the first resin comprises depositing the first resin into a first region;
removing a first portion of the first resin within the first region to form a second region;
etching the first resin in the first region with a first nano-pattern;
striping the substrate;
cleaning the substrate;
imprinting a second resin onto the first surface of the substrate, wherein imprinting the second resin comprises depositing the second resin into the second region; and
etching the second resin in the second region with a second nano-pattern.

19. The method of claim 18, wherein the second resin is deposited into a third region and wherein the third region is not contiguous with the first region.

20. The method of claim 18, further comprising imprinting a third resin onto a second surface of the substrate, wherein imprinting the third resin comprises depositing the third resin onto a fourth region of the substrate, and wherein the second surface of the substrate is opposite the first surface and the fourth region is opposite the second region.
